(19) United States
(12) Patent Application Publication
(10) Pub. No.: US 2017/0340976 A1
(43) Pub. Date: Nov. 30, 2017

(54) METHOD FOR PROVIDING A PUZZLE GAME AND GAME SYSTEM FOR PROVIDING A PUZZLE GAME USING THE SAME

(71) Applicants: NHN Entertainment Corporation, Seongnam-si (KR); NHN PixelCube Corporation, Seongnam-si (KR)

(72) Inventors: Seong Hyeon KIM, Seongnam-si (KR); Seung Hye Lee, Seongnam-si (KR); Sang Moon Kim, Seongnam-si (KR); Eun Kyung Kim, Seongnam-si (KR)

(21) Appl. No.: 15/603,711

(22) Filed: May 24, 2017

(30) Foreign Application Priority Data
May 24, 2016 (KR) 10-2016-0063271
Jun. 24, 2016 (KR) 10-2016-0079005
Jul. 20, 2016 (KR) 10-2016-0091852

(51) Int. Cl. A63F 13/822; A63F 13/847; A63F 13/79; A63F 13/46; A63F 13/426; A63F 13/92; A63F 13/2145

(52) U.S. Cl. CPC A63F 13/822; A63F 13/92; A63F 13/847; A63F 13/2145; A63F 13/46; A63F 13/426; A63F 13/79

(57) ABSTRACT

A method for providing a puzzle game performed by a game server connected to a user terminal via s network including the steps of: performing a user login process in response to receiving login information from the user terminal; and executing the puzzle game on the user terminal in response to receiving a game execution signal from the user terminal. Game action is performed if it is determined that a puzzle block elimination condition is satisfied according to a cumulative result of eliminating the puzzle blocks.

### CROSS REFERENCE TO RELATED APPLICATIONS

This application claims priority from and the benefit of Korean Patent Application Nos. 10-2016-0063271, filed on May 24, 2016, 10-2016-0079005, filed on Jun. 24, 2016, and 10-2016-0091852, filed on Jul. 20, 2016, which is hereby incorporated by reference for all purposes as if fully set forth herein.

### BACKGROUND

### Field

The present invention relates to a puzzle game method and a game system for providing a puzzle game using the same and, more particularly, to a puzzle game method and system for providing a puzzle game eliminating three or more puzzle blocks having the same is color.

Discussion of the Background

Recently, various kinds of games provided in the form of apps for a smartphone are being developed. One such game is a puzzle game that progresses while eliminating three or more puzzle blocks having the same color.

A brief description of the currently serviced puzzle game method is as follows. First, when puzzle blocks, each of which has any one of a plurality of colors, is displayed on a smartphone, a user exchanges one of the puzzle blocks with a neighboring puzzle block through a touch input. At this time, if it is determined that three or more puzzle blocks having the same color in at least one direction are arranged according to the exchange of the puzzle blocks, the three or more puzzle blocks are eliminated and a predetermined score is acquired.

However, because such a conventional block game has a simple progress method in which the puzzle blocks are eliminated and scores are obtained by merely exchanging the puzzle blocks, users may easily lose interest and fun, which means reducing loyalty of users.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a game system including a game server and a user terminal.

Additional aspects will be set forth in the detailed description which follows, and, is in part, will be apparent from the disclosure, or may be learned by practice of the inventive concept.

Exemplary embodiments disclose a method for providing a puzzle game performed by a game server connected to a user terminal via a network comprising the steps of: performing a user login process in response to receiving login information from the user terminal; and executing the puzzle game on the user terminal in response to receiving a game execution signal from the user terminal.

The step of executing the puzzle game comprises determining a game object having a game skill capable of performing a game action when a puzzle block elimination condition is satisfied; displaying puzzle blocks, each of which has one of a plurality of colors, on a display unit of the user terminal; exchanging one of the puzzle blocks with one of neighboring puzzle bocks according to a user input; determining if a matching block group is generated as a result of exchanging puzzle blocks, the matching block group including at least three puzzle blocks having the same color that are arranged consecutively in a direction; eliminating the matching block group; and performing the game action if it is determined that the puzzle block elimination condition is satisfied according to a cumulative result of eliminating the puzzle blocks.

The puzzle block elimination condition may be that X first type puzzle blocks are eliminated cumulatively (X is an integer equal to or greater than 1).

The first type puzzle block includes at least one of: a general puzzle block that can be eliminated when the matching block group is formed; and a special puzzle block capable of further eliminating at least one puzzle block when the special puzzle block forms a matching block group and the matching block group is eliminated.

The game action comprises at least one of: a first action eliminating Z second type puzzle blocks when there is at least one second type puzzle block among the puzzle blocks displayed on the display unit (Z is an integer equal to or greater than 1); a second action eliminating at least one puzzle block disposed in at least one specific area; and a third action generating L special puzzle blocks (L is an integer equal to or greater than 1).

Exemplary embodiments also disclose a method for providing a puzzle game performed by a game server connected to a user terminal of a user via a network comprising the steps of: performing a user login process in response to receiving login information from the user terminal; receiving a game score of a first user obtained by performing the puzzle game in a game stage in which the first user participates from a first user terminal of the first user; receiving a game score of a second user by performing the puzzle game in the game stage from a second user terminal of the second user, wherein the second user participates in the game stage to perform the puzzle game together with the first user; and transmitting at least a part of a reward for clearing the stage to the first and second terminals, respectively, when a total score that is a sum of the score obtained by the first user and the second user reaches a reference score.

The step of transmitting at least a part of a reward comprises: providing a first share of the reward to the first terminal according to a contribution of the first user to clearing the stage; and providing a second share of the reward to the second terminal according to a contribution of the second user to clearing the stage, wherein the contribution of first user is a ratio of the game score of the first user to the total score, and the contribution of the second user is a ratio of the game score of the second user to the total score.

Exemplary embodiments also disclose a method for providing a puzzle game performed by a game server connected to a user terminal of a user via s network comprising the steps of: performing a user login process in response to receiving login information from the user terminal; allowing the user terminal access a game room to perform the puzzle game; providing game money to the user terminal according to a game result performed by the user terminal in the game room; and providing a game display object for the user terminal in exchange with the game money.

The step of providing a game display object comprises: determining whether a game display object creation condition is satisfied; and providing the game display for the user terminal in exchange with the game money if the game display object creation condition is satisfied.

The step of allowing the user terminal to access a game room to perform the puzzle game comprises displaying a game room group including a plurality of game rooms on the user terminal, wherein the game rooms have a plurality of levels; determining a play game room in response to the user selecting one of the plurality of game rooms of the game room group; and allowing the user terminal to enter the game room to perform the puzzle game.

The game display object creation condition is that a number of game rooms of the game room group having a score over a reference score is greater than a reference number.

Exemplary embodiments also disclose a puzzle game system comprising: a main control unit configured to perform a user login process in response to receiving login information from the user terminal; a game execution unit configured to execute the puzzle game on the user terminal in response to receiving a game execution signal from the user terminal; and an object management unit configured to determine a game object having a game skill capable of performing a game action when a puzzle block elimination condition is satisfied.

The game execution unit is further configured to display puzzle blocks, each of which has one of a plurality of colors, on a display unit of the user terminal; to exchange one of the puzzle blocks with one of neighboring bocks according to a user input; to determine if a matching block group is generated as a result of exchanging puzzle blocks, the matching block group comprising at least three puzzle blocks having the same color that are arranged consecutively in a direction; to eliminate the matching block group; and to perform the game action if it is determined that the puzzle block elimination condition is satisfied according to a cumulative result of eliminating the puzzle blocks.

Exemplary embodiments also disclose a puzzle game system comprising: a main control unit configured to perform a user login process in response to receiving login information from the user terminal, to receive a game score of a first user obtained by performing the puzzle game in a game stage in which the first user participates from a first user terminal of the first user, and to receive a game score of a second user by performing the puzzle game in the game stage from a second user terminal of the second user, wherein the second user participates in the game stage to perform the puzzle game together with the first user; and a game reward unit configured to transmit at least a part of reward for clearing the stage is transmitted to the first and second terminals, respectively, when a total score that is a sum of the score obtained by the first user and the second user reaches a reference score.

Exemplary embodiments also disclose a puzzle game system comprising: a main control unit configured to perform a user login process in response to receiving login information from the user terminal; a game proceeding unit configured to allow the user terminal access a game room to perform the puzzle game, and to provide game money to the user terminal according to a game result performed by the user terminal in the game room; and a game display object management unit configured to provide a game display object for the user terminal in exchange with the game money.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a conceptual diagram illustrating a network connection relationship of a game system according to a first exemplary embodiment of the present invention.

FIG. 2 is a block diagram illustrating the game system of FIG. 1 in detail.

FIG. 3 is a flowchart illustrating a puzzle game method performed by the game system of FIGS. 1 and 2.

FIG. 4 is a diagram illustrating the relationship among a main screen, a game preparation screen and a game execution screen displayed on the user terminal.

FIG. 5 is a diagram illustrating the relationship between a game preparation screen and a character management screen displayed on the user terminal.

FIG. 6 is a diagram illustrating a relationship between a main screen and a character management screen displayed on a user terminal.

FIG. 7 is a diagram showing an example of increasing a level of a game character.

FIG. 8 is a diagram illustrating an example of eliminating Z blocks of the second type puzzle block when X blocks of the first type puzzle block are eliminated.

FIG. 9 is a diagram illustrating an example of eliminating puzzle blocks in a specific area at a predetermined probability when X blocks of a first type puzzle block are eliminated.

FIG. 10 is a diagram illustrating an example of generating L second type puzzle blocks when X blocks of the first type puzzle block are eliminated.

FIG. 11 is a diagram illustrating an example of performing a game action Y times when X blocks of the first type puzzle are eliminated.

FIG. 12 is a diagram showing an example of increasing the explosion timer by 1 when X blocks of the first type puzzle block are eliminated.

FIG. 13 is a conceptual diagram illustrating a connection relationship of a game system according to a second exemplary embodiment of the present invention.

FIG. 14 is a block diagram illustrating the game system of FIG. 13 in detail.

FIG. 15 is a flowchart illustrating a puzzle game method performed by the game system of FIGS. 13 and 14.

FIG. 16 is an example of a main lobby screen displayed on the user terminal.

FIG. 17 is a diagram for explaining the relationship among the main lobby screen, the game preparation screen and the game execution screen displayed on the user terminal.

FIG. 18 is a diagram for explaining a challenge stage generation step of the puzzle game method of FIG. 15.

FIG. 19 is a flowchart for explaining a stage generation method according to user selection.

FIG. 20 is a flowchart for explaining a step of providing game stages of FIG. 19.

FIG. 21 is an exemplary game stage discovery message displayed on a game execution screen displayed on the user terminal.

FIG. 22 is an example of a stage list screen displayed on the user terminal.

FIG. 23 is a diagram for explaining the relationship among the stage lobby screen and the game execution screen displayed on the user terminal.

FIG. 24 is a diagram for explaining the relationship between the main lobby screen, the stage list screen, and the stage lobby screen displayed on the user terminal.

FIG. 25 is a flowchart for explaining a stage generation method according to an invitation.

FIG. 26 is a diagram illustrating an example of a message box and an external invitation message displayed on the user terminal.

FIG. 27 is a flowchart for explaining a stage generation method according to an event notification message.

FIG. 28 is an example of an event notification message displayed on the user terminal.

FIG. 29 is a flowchart for explaining a participant adding step of the puzzle game method of FIG. 15; FIG.

FIG. 30 is an example of a user list screen displayed on a user terminal.

FIG. 31 is a diagram for explaining the relationship between the stage main screen and the user list screen displayed on the user terminal.

FIG. 32 is a diagram illustrating an example of game scores obtained by a plurality of users.

FIG. 33 is a conceptual diagram illustrating the connection relationship of the game system according to a third exemplary embodiment of the present invention.

FIG. 34 is a block diagram illustrating the game system of FIG. 33 in detail.

FIG. 35 is a flowchart illustrating a puzzle game method performed by the game system of FIGS. 33 and 34.

FIG. 36 is a diagram illustrating an example of a group room list screen and a game room group screen displayed on the user terminal.

FIG. 37 is a diagram for explaining the relationship among a game room group screen, a game preparation screen, and a game execution screen displayed on the user terminal.

FIG. 38 is a simplified example of a game room group screen displayed on the user terminal.

FIG. 39 is an example of a display map screen displayed on the user terminal.

FIG. 40 is an example of a display list screen displayed on the user terminal.

FIG. 41 is a diagram for explaining the relationship among a game room group screen, a game display object map screen, and a game display object list screen displayed on the user terminal.

FIG. 42 is a diagram for explaining the relationship between the game display object list screen and the item acquisition screen displayed on the user terminal.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, is well-known structures and apparatus are shown in block diagram form in order to avoid unnecessarily obscuring various exemplary embodiments.

In the accompanying figures, the size and relative sizes of elements may be exaggerated for clarity and descriptive purposes. Also, like reference numerals denote like elements.

When an element is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element or layer, there are no intervening elements present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various elements, components, regions, and/or sections, these elements, components, regions, and/or sections should not be limited by these terms. These terms are used to distinguish one element, component, region, and/or section from another element, component, region, and/or section. Thus, a first element, component, region, and/or section discussed below could be termed a second element, component, region, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

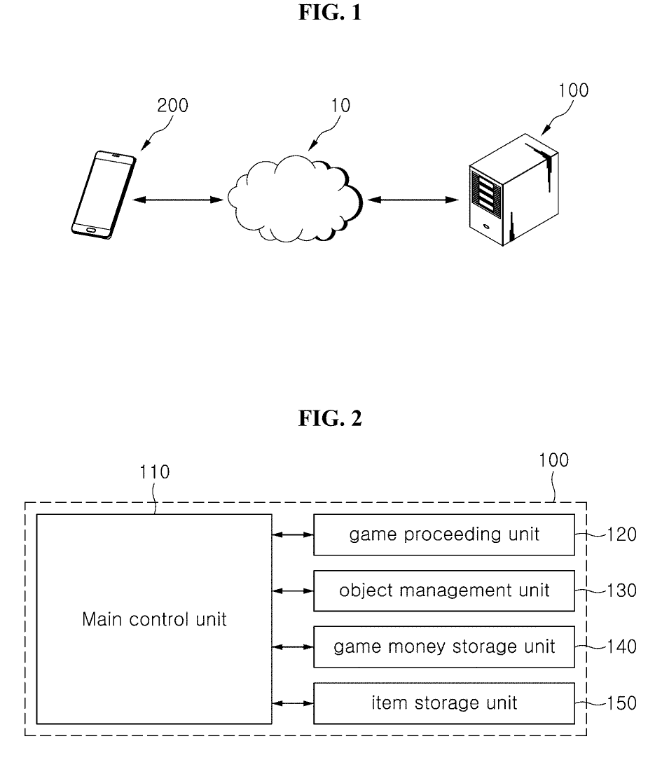

FIG. 1 is a conceptual diagram illustrating a connection relationship of a game system according to a first embodiment of the present invention, and FIG. 2 is a block diagram illustrating the game system of FIG. 1 in detail.

Referring to FIGS. 1 and 2, a game system 100 according to an exemplary embodiment of the present invention, which may be computer system providing a puzzle game for at least one user terminal 200 connected via the network 10, may include a main control unit 110, a game proceeding unit 120, an object management unit 130, a game money storage unit 140, and an item management unit 150. The user terminal 200 may be a smart device including a smart phone, a tablet PC, and the like capable of running an application program, and displaying various information through the display unit.

In the present exemplary embodiment, the components of the game system 100 may be physically separate computer systems from each other, or functionally separate programs within one computer system. In addition, the components of the game system 100 may be physically or functionally separated programs within a plurality of computer systems.

The main control unit 110 may perform an interface function of connecting to the user terminal 200 through the network 10 to exchange signals with the user terminal 200 and perform user login process in response to receiving login information of the user from the user terminal 200. The user login may be performed in conjunction with an account currently used by the user A, for example, an account of Google®, Facebook®, Naver, and the like.

In addition, the main control unit 110 may be connected to and controls the game proceeding unit 120, the object management unit 130, the game money storage unit 140, and the item management unit 150 to perform an integrated management of the game.

After the user's login is completed by the main control unit 110, the game proceeding unit 120 executes the puzzle game on the user terminal 200 in response to receiving the game execution signal from the user terminal 200. Specifically, the game proceeding unit 120 displays puzzle blocks composed of a plurality of color types on the display unit of the user terminal 200, exchanges one of the puzzle blocks with one of neighboring puzzle blocks according to user manipulation input, and, in response to three or more puzzle blocks having the same color being arranged consecutively in at least one direction of the puzzle blocks, eliminates the three or more puzzle blocks.

The object management unit 130 may manage a game object capable of performing a predetermined function in a game stage. For example, the game object may include a game character that can help perform the puzzle game in a game stage.

The object management unit 130 stores at least one game object owned by the user A. The game object may have a game skill capable of performing a predetermined game action when a predetermined condition for elimination of a puzzle block (hereinafter referred to as a “puzzle block elimination condition”) is satisfied. The game skill may be a score boost skill that may increase scores obtained at the game stage by a certain percentage. For example, the puzzle block elimination condition may be a condition that X first type puzzle blocks are eliminated (where X is an integer equal to or greater than 1) cumulatively, and the game skill may be a skill of repeating the game action Y times (Y is an integer greater than 1) when the puzzle block elimination condition is satisfied.

The object management unit 130 may determine a game character to be applied to the game stage by a user selection among the game characters owned by the user through the user terminal 200. After that, the game proceeding unit 120 assesses the accumulated elimination result of the puzzle block, and performs the game action Y times if it determines that X first type puzzle blocks have been eliminated cumulatively.

The object management unit 130 may add a new game character, in response to a user input through the user terminal 200, using game money or other method, or may increase level of the game character using other character possessed by the user.

The game money storage unit 140 stores game money of the user A. The game money may be acquired through performing game in a game stage, mission completion, various payment methods, and other methods.

The item storage unit 150 may store various items that may be applied to a game stage. The item may include a block-exchange-time increase item capable of increasing the allowed number of exchanging block position, and a special block creation item capable of generating a special block that may eliminate at least one puzzle block in the game stage. The item may be acquired through game execution of the game stage, mission completion, etc., or may be acquired by various payment methods and other methods.

Hereinafter, a process performed by the game system 100 and/or the user terminal 200 will be described in detail.

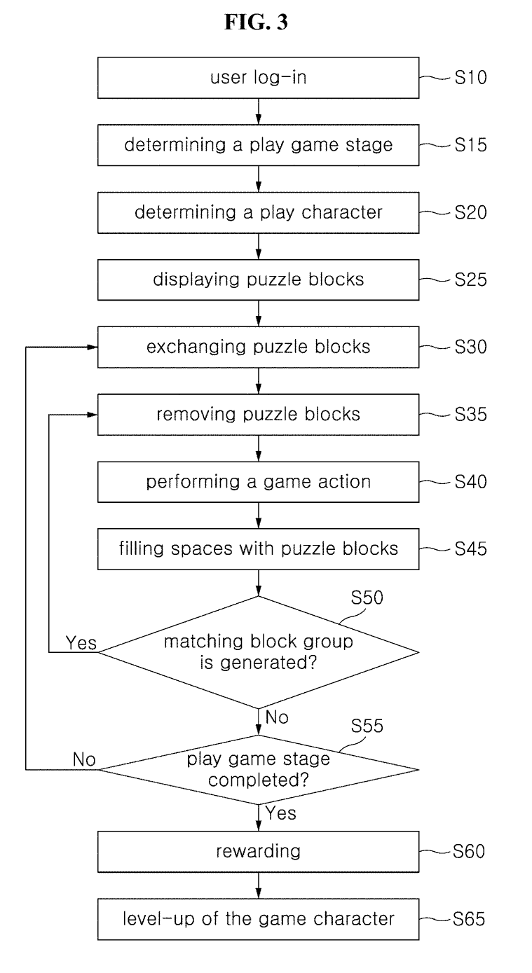

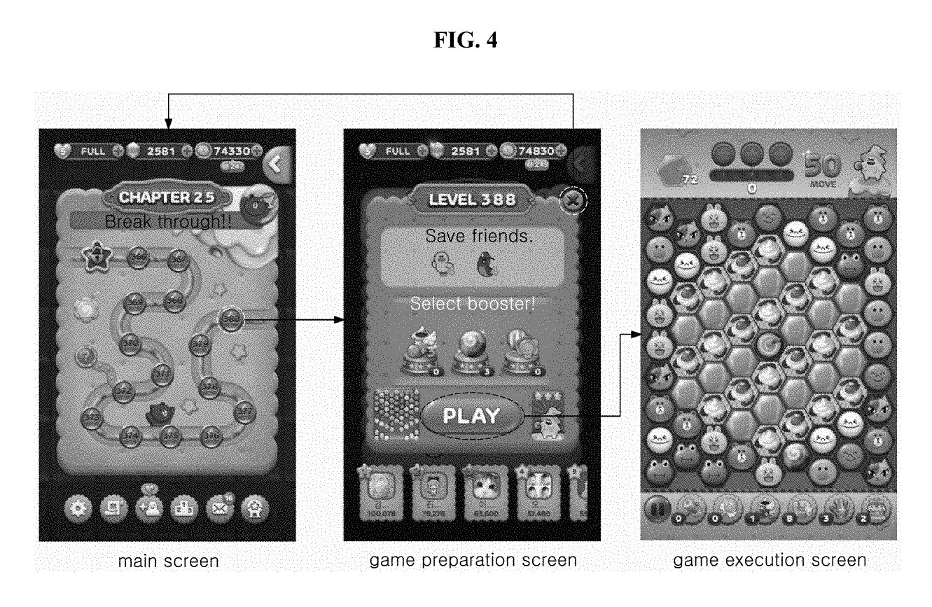

FIG. 3 is a flowchart illustrating a puzzle game process performed by the game system of FIG. 1, and FIG. 4 illustrates a relationship among a main screen, a game preparation screen, and a game execution screen, which are displayed on a user terminal.

Referring to FIGS. 1, 2, 3 and 4, when the user terminal 200 executes a game program, for example, game application, the user terminal 200 accesses the main control unit 110 of the game system 100 through the network 10 and then the main control unit 110 performs user log-in process in response to receiving the login information of the user A from user terminal 200 (S10). At this time, if the main control unit 110 stores the login information of the user A obtained in previous a login process of the user A, the main control unit 110 may automatically perform the login process without requiring any input information. Meanwhile, the user login may be performed in association with an account currently used by the user A, for example, an account of Google®, Facebook®, Naver, or the like.

As such, when the user login process is completed, the user terminal 200 displays the main screen as shown in the left screenshot of FIG.4. For example, the main control unit 110 may control the user terminal 200 to display the main screen after completing the user login process. The main screen may include, for example, one of a plurality of chapters, and each of the chapters may include a plurality of game stages.

Subsequently, the main control unit 110 selects one of the game stages according to a user's input through the user terminal 200 to perform the puzzle game thereon (hereinafter, referred to as a ‘play game stage’) (S15). For example, when the user A selects one of the plurality of game stages displayed on the main screen to select the play game stage, the user terminal 200 displays the game preparation screen, as shown in the middle screenshot of FIG. 4. The game preparation screen may include at least one of a preview display area for displaying the play game stage in advance, a character display area for displaying a game character to be applied to the play game stage, an item application area for selecting one of at least one item to apply it to the play game stage, a ranking display area for displaying rankings of other users registered as friends, an execution icon for executing the play game stage, and the like. On the other hand, if the user clicks the cancel icon, the game preparation screen may be returned to the main screen.

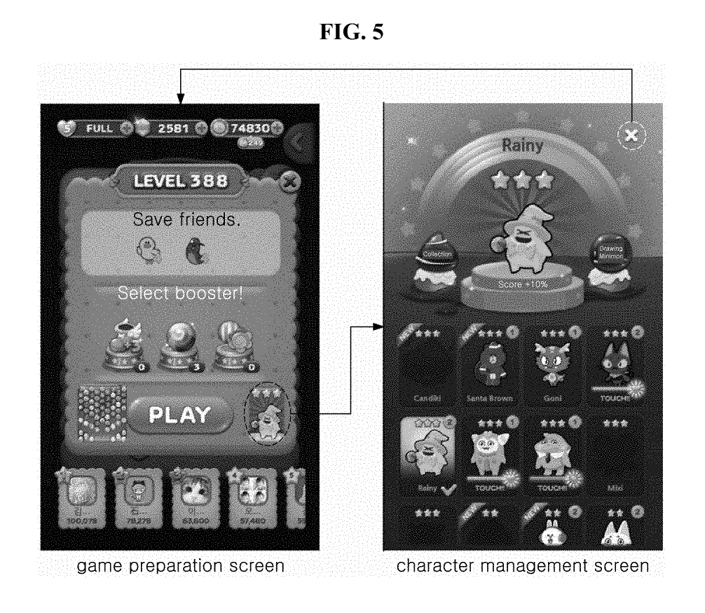

FIG. 5 illustrates relationship between a game preparation screen and a character management screen displayed on the user terminal.

Referring to FIG. 5, the object management unit 130 may determine the play character used to perform the play game stage, in response to the user input of selecting one of the at least one character possessed by the user A action through the user terminal 200 (S20).

In the present exemplary embodiment, the object management unit 130 may control the user terminal 200 to display a character management screen for determining the play character. The character management screen may include a character list display area displaying game characters to select the play character, a play character display area displaying the play character, a character add function for adding a new game character, and the like.

In the present exemplary embodiment, the character management screen may be a screen that is switched from the game preparation screen, as shown in FIG. 5. That is, when the user clicks the character display area in the game preparation screen, the user terminal 200 may switch the game preparation screen to the character management screen. On the other hand, if the user clicks the cancel icon, the character management screen may be returned to the game preparation screen.

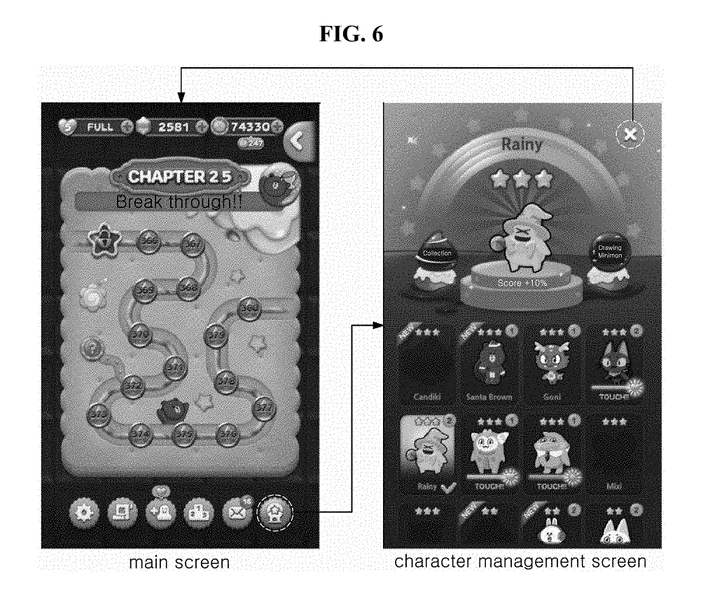

FIG.6 illustrates a relationship between a main screen and a character management screen displayed on a user terminal.

Referring to FIGS.1, 2, 3 and 6, unlike FIG. 5, the character management screen may be a screen switched from the main screen. That is, when the user clicks the character management icon displayed in the main screen, the user terminal 200 may switch the main screen to the character management screen. On the other hand, if the user clicks the cancel icon, the character management screen may be returned to the main screen. Here, in case of determining the play character in the same manner as FIG. 6, the step S20 of determining the play character may be performed prior to the step S15 of determining the play game stage.

If it is determined that a game character had been selected in the previous play of the game, the object management unit 130 may automatically determine the same character as the play character. In this case, when it is desired to change the automatically determined play character to another character, the object management unit 130 may change the play character in response to a user input of selects one of the game characters possessed by the user.

Then, when the user A clicks the execution icon, the game proceeding unit 120 displays puzzle blocks having a plurality of colors on the user terminal 200 (S25). That is, the user terminal 200 may switch the game preparation screen to a game execution screen.

In the present exemplary embodiment, the game execution screen may include a play area for performing the puzzle game and a peripheral area adjacent to the play area. Here, the puzzle blocks having a plurality of colors may be displayed in the play area, and the play characters may be displayed in the peripheral area. For example, the colors of the puzzle blocks may include red, blue, green, gray, and purple.

Then, the game proceeding unit 120 may exchange one of the puzzle blocks with one of neighboring blocks in response to a user input action through the user terminal 200 (S30). For example, the user A may exchange one of the puzzle blocks displayed in the play area with one of neighboring blocks that is adjacent to the one of the puzzle blocks in six directions.

Then, the game proceeding unit 120 determines whether three or more consecutive puzzle blocks in a direction have the same color (hereinafter, referred to as ‘matching block group’) as a result of block exchange, and if so, eliminates the matching block group (S35). Here, if the matching block group includes the first type puzzle blocks, the number of eliminations of the first type puzzle block may be summed up to X cumulatively. On the other hand, the cumulative number of eliminations of the first type puzzle blocks may be displayed in the peripheral area in a form of a gauge. For example, it may be displayed in a form of explosion-like contour surrounding the play character and filled with a yellow color within the explosion-like contour as much as the number of eliminations of the first type puzzle blocks.

Subsequently, if it is determined that cumulative number of eliminations of the first type puzzle blocks reaches X, the game proceeding unit 120 may perform a game action Y times (S40). That is, if the cumulative number of eliminations of the first type puzzle blocks reaches X, the explosion-like contour is fully filled with yellow color and the game action may be performed Y times.

In the present exemplary embodiment, the play character may be displayed in the play area for a certain period before, after, or simultaneously with performing the game action Y times. Also, even before the game action is performed Y times, the play character may be displayed in the play area for a certain period before or after the matching block group is eliminated. The process of performing the game action Y times will be described in detail using a separate drawing.

Then, the game proceeding unit 120 fills spaces from which the matching block group has been eliminated with neighboring puzzle blocks (S45). If no neighboring block exists, the game proceeding unit 120 generates puzzle blocks having arbitrary colors to fill the spaces.

The game proceeding unit 120 may determine whether a new matching block group is generated after step S45. At this time, if the game proceeding unit 120 determines that the new matching block group is generated, the game proceeding unit 120 may again sequentially perform the steps S35 to S45. In other words, the game proceeding unit 120 may continue the steps S35 to S45 until another new matching block group is not generated.

On the other hand, if the game proceeding unit 120 determines that the new matching block group is not generated, it can determine whether the play game stage has ended (S55). If the game proceeding unit 120 determines in step S55 that the play game stage does not end, the game proceeding unit 120 may perform the steps S30 to S50 again in order. The termination of the play game stage may include a mission completion and a failure of the play game stage. On the other hand, even if the steps S30 to S50 are sequentially and repeatedly performed, the game action may be performed only up to W times (where W is an integer equal to or greater than Y).

If the game proceeding unit 120 determines in step S55 that the play game stage is terminated, the game proceeding unit 120 provide the user A with various rewards, for example, a game money, icons, items and the like (S60).

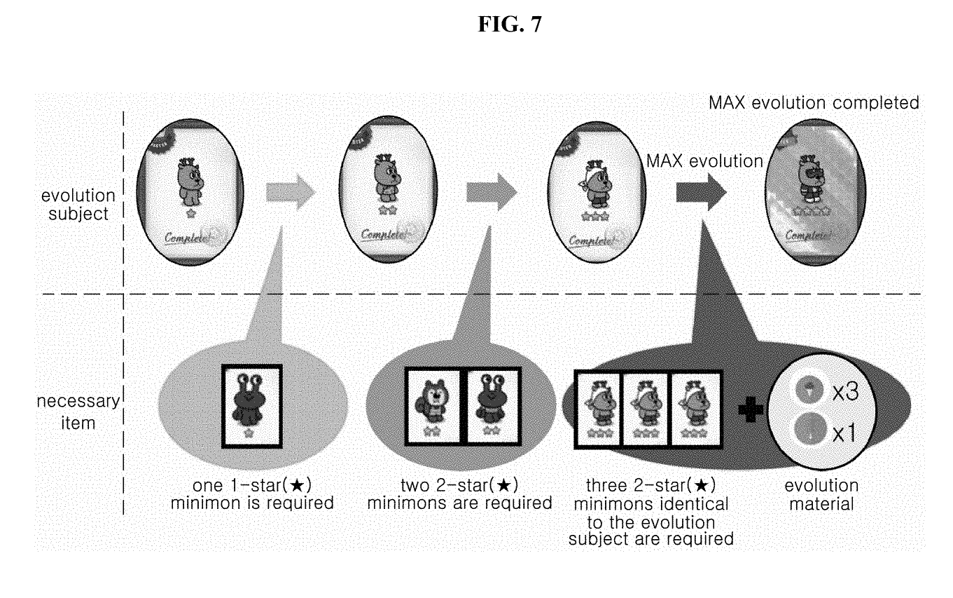

FIG. 7 is a diagram showing an example of increasing the level of the game character.

Referring to FIGS.1, 2, 3, and 7, the object management unit 130 increases the level of the game character by using at least one of the other game characters, game money, and items (S65).

For example, when raising the level of a game character from a one star level to a two star level, one game character of a one star level may be used, and when raising a game character from a two star level to a three star level, two game characters may be used. In addition, when leveling up a game character from a three star level to a four star level, three identical game characters having the same level as the play game character and another evolution material may be used. Here, the evolution material may be an item that is provided as reward for performing a game stage, and may be an item that can be purchased with game money.

Hereinafter, the step of performing the game action Y times in step S40 will be described in detail with reference to another drawing.

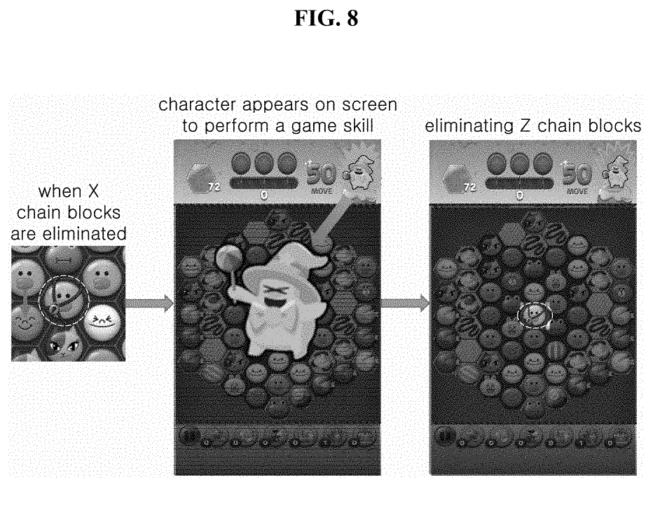

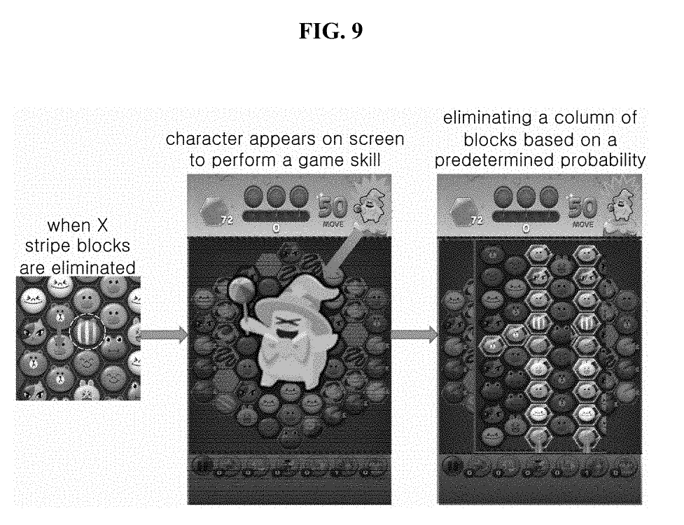

FIG. 8 is a diagram illustrating an example of eliminating Z blocks of the second type puzzle block when X blocks of the first type puzzle block are eliminated.

Referring to FIG.1, 2, and 8, the game proceeding unit 120 may perform the game action once when X blocks of the first type puzzle block are eliminated cumulatively. The game action may include a first action to eliminate Z second type puzzle blocks (Z is an integer equal to or greater than 1).

In the present exemplary embodiment, the first type puzzle block may be any one of a general puzzle block, a special puzzle block, and other puzzle blocks.

The general puzzle block may be a puzzle block that can be a part of a matching block group together with other puzzle blocks. The special puzzle block may be a puzzle block capable of additionally eliminating at least one puzzle block when the special block forms a matching block group together with other puzzle blocks and the matching puzzle block is eliminated. The other puzzle block may be a puzzle block other than the general puzzle block and the special puzzle block, for example, a non-exchangeable block, multiple elimination blocks, a convertible block, and a timer bomb block.

The non-exchangeable block is a puzzle block that cannot be exchanged with neighboring puzzle blocks and can be eliminated only when neighboring puzzles are eliminated. The multiple elimination block may be a puzzle block that cannot be exchanged with neighboring puzzles and can be eliminated only when the matching block group is formed M times with other puzzle blocks (where M is an integer of 2 or more). The convertible block may be a puzzle block that can be converted to any puzzle block when the convertible block forms a group of matching blocks together with other puzzle blocks. The timer bomb block may be a puzzle block which terminates the game in failure if the timer bomb block is not eliminated until exchanging blocks is performed N times (where N is an integer of 2 or more).

The second type puzzle block may be any one of a general puzzle block, a special puzzle block, and other puzzle blocks. For example, the second type puzzle block may be a puzzle block of the same as the first type puzzle block. Here, if more than Z of the second type puzzle block exists, Z second type puzzle blocks may be randomly determined to be eliminated.

For example, as shown in FIG. 8, when X chain blocks are eliminated, Z chain blocks may be eliminated while a play character is displayed in the play area. The chain block is a kind of multiple elimination block that can be eliminated only when it forms a matching block group twice with other puzzle blocks. The chain block has a look of a general puzzle block having a chain graphic.

FIG. 9 is a diagram illustrating an example of eliminating puzzle blocks in a specific area at a predetermined probability when X blocks of a first type puzzle block are eliminated.

Referring to FIGS. 2 and 9, the game proceeding unit 120 may perform the game action at a predetermined probability when X blocks of the first type puzzle block are eliminated. The predetermined probability may be a fixed probability value, or may be randomly selected from a plurality of probability values.

The game action may be a second action that eliminates at least one puzzle block disposed in at least one specific area. The specific region may be a first region having a geometric pattern, for example, a circle shape, an equilateral triangle shape, a flower shape, or the like, of which center is a specific block. Alternatively, the specific region may be a second region having a linear shape. The position of generating the specific region may be randomly determined.

For example, as shown in FIG. 9, when X stripe blocks are eliminated cumulatively, the play characters are displayed in the play area and the puzzle blocks arranged in a row can be additionally eliminated with a 5% or 15% probability. In this case, the stripe block is an example of a special puzzle block. When the stripe block formed a matching block group with other puzzle blocks and the matching block group is eliminated, the stripe puzzle block can eliminate some other blocks arranged in the direction of the stripe of the stripe block at a predetermined probability.

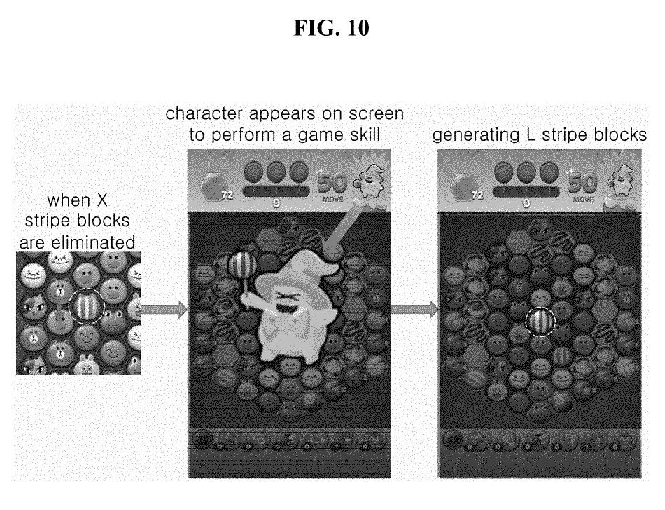

FIG. 10 is a diagram illustrating an example of generating L second type puzzle blocks when X blocks of the first type puzzle block are eliminated.

Referring to FIGS. 2 and 10, the game proceeding unit 120 may perform the game action once when X blocks of the first type puzzle block are eliminated. In this case, the game action may be a third action that generates L special puzzle blocks that can eliminate at least one puzzle block when a matching block group is formed and eliminated along with other puzzle blocks (L is an integer of 1 or more). Here, where to generate the special block may be randomly determined.

For example, as shown in FIG. 10, when X blocks of stripe block are eliminated, a play character is displayed in the play area and L blocks of stripe block can be generated.

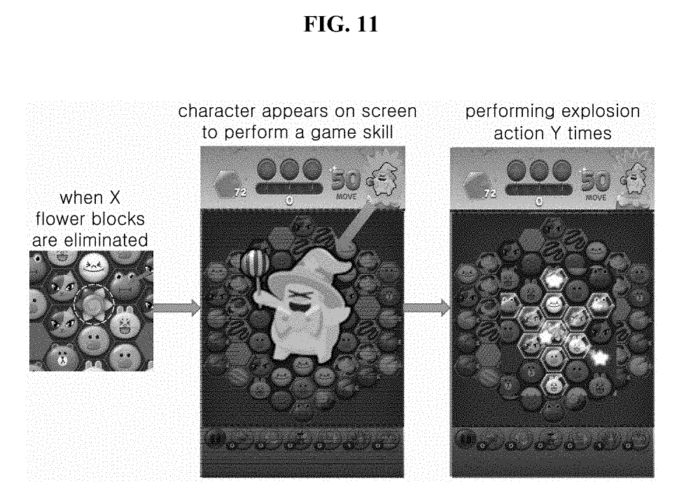

FIG. 11 is a diagram illustrating an example of performing a game action Y times when X the first type puzzle blocks are eliminated.

Referring to FIGS. 2 and 11, the game proceeding unit 120 may perform the game action Y times when X blocks of the first type puzzle block are eliminated cumulatively. For example, when X flower blocks are eliminated cumulatively, as shown in FIG. 11, a play character is displayed in the play area and an explosion action may be performed twice in succession. In this case, the flower block, as an example of a special puzzle block, performs an explosion action that eliminates puzzle blocks arranged in a flower shape in six directions when the flower block forms a matching block group together with other puzzle blocks and the matching block group is eliminated.

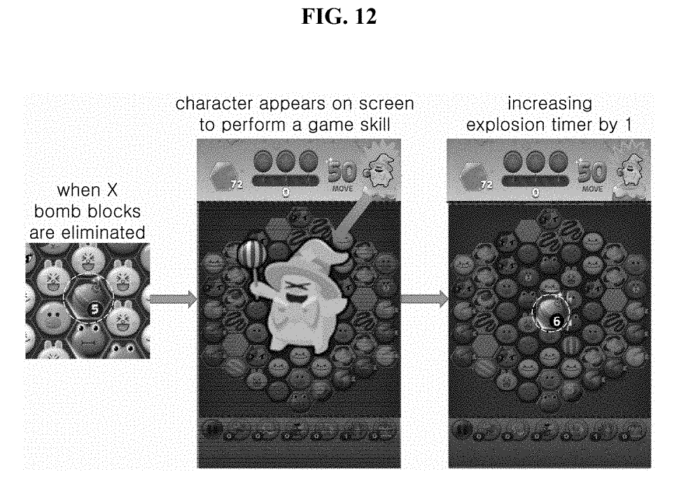

FIG. 12 is a diagram illustrating an example of increasing the explosion timer by 1 when X blocks of the first type puzzle block are eliminated.

Referring to FIGS. 2 and 12, the game proceeding unit 120 may perform the game action once when X blocks of the first type puzzle block are eliminated. The game action may be an action capable of increasing the explosion timer of the bomb block. Here, the bomb block is an example of a special block of which game action is decreasing the explosion timer by 1 whenever an exchange of the puzzle blocks is performed and terminating the game stage in failure by explosion when the explosion timer becomes 0 (zero).

As described above, according to the present exemplary embodiment, the game character determined by the user's choice in the play game stage has the game skill capable of performing the specific game action Y times in case of eliminations of X specific puzzle blocks. Therefore, when the specific puzzle block is cumulatively eliminated up to X through the block exchange, the game action may be performed Y times in addition to the elimination of the matching block group.

In addition, when a plurality of game characters have different game skills, the user selects a game character that can best assist the next game stage, which help more effectively complete the mission of the game stage can do. Accordingly, when the user selects a game character to perform game actions, it helps the completion of the mission of the game stage more easily, and it is possible to double the fun and interest of the game to the user.

On the other hand, when the game action is performed, as the game character is displayed in the play area and disappears after performing game actions, it is visualized that the game action is activated, thereby doubling the fun.

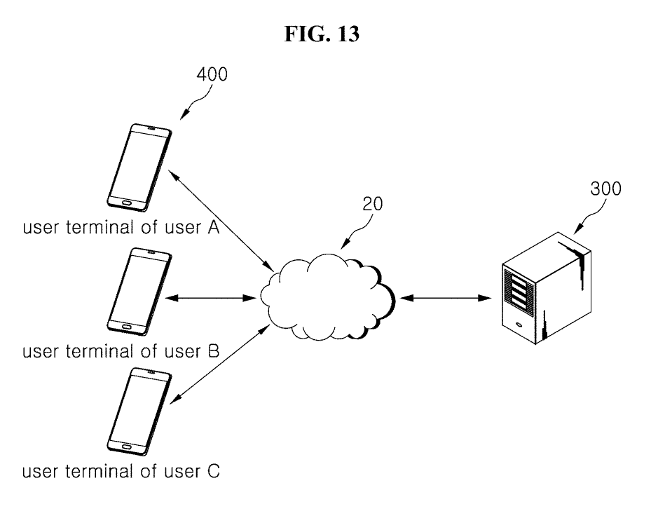

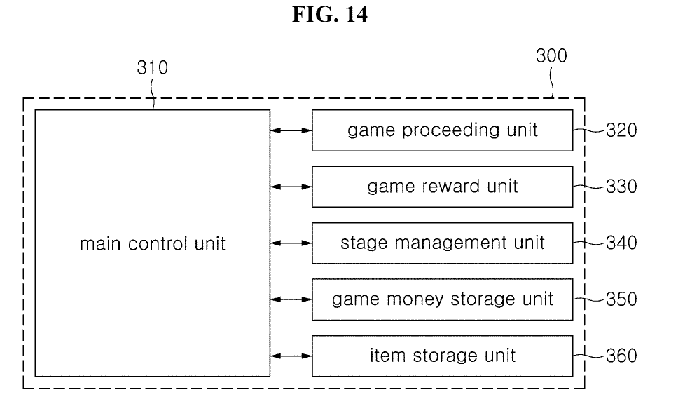

FIG. 13 is a conceptual diagram illustrating a connection relationship of a game system according to another exemplary embodiment of the present invention, and FIG. 14 is a block diagram illustrating the game system of FIG. 13 in detail.

Referring to FIGS. 13 and 14, the game system 300 according to the present exemplary embodiment is a computer system connected to at least one user terminal 400 via a network 10 to provide a puzzle game. The game system 300 may include a game proceeding unit 320, a game reward unit 330, a stage management unit 340, a game money storage unit 350, and an item management unit 360. The user terminal 400 may be a smart device including a smart phone, a tablet PC, and the like capable of running an application program and displaying various screens through a display unit.

In the present exemplary embodiment, the components of the game system 300 may be physically separate computer systems from each other, or functionally separate programs within one computer system. In addition, the components of the game system 300 may be physically or functionally separated programs within a plurality of computer systems.

The main control unit 310 may perform an interface function of connecting to the user terminal 400 through the network 20 to exchange signals with the user terminal 400 and may perform user login process in response to receiving login information of the user A from the user terminal 400. The user login may be performed in conjunction with an account currently used by the user A, for example, an account of Google®, Facebook®, Naver, and the like.

In addition, the main control unit 310 may be connected to and controls the game proceeding 320, the game reward unit 330, the stage management unit 340, the game money storage unit 350, and the item storage unit 360 to perform a integrated management of the game.

After the user's login is completed by the main control unit 310, the game proceeding unit 320 executes the puzzle game on the user terminal 400 in response to receiving the game execution signal from the user terminal 200. Specifically, the game proceeding unit 320 displays puzzle blocks composed of a plurality of color types on the display unit of the user terminal 400, exchanges one of the puzzle blocks with one of neighboring puzzle blocks according to user manipulation input, and, in response to three or more puzzle blocks having the same color being arranged consecutively in at least one direction of the puzzle blocks, eliminates the three or more puzzle blocks.

The game reward unit 330 may provide various rewards, for example, game money, items, and the like, for the user A's terminal 400 according to a result of performing a game stage through the game proceeding unit 320.

The stage management unit 340 can manage various types of stages which a plurality of users can participate in to perform a puzzle game together. For example, the stage management unit 340 may provide one of various stages for the user terminal 400 of the user A to execute the stage in the user terminal 400 of the user A.

The game money storage unit 350 stores game money held by the user A. The game money may be acquired through game performance in a game stage, mission completion, etc., or may be acquired by various payment methods and other methods.

The item storage unit 360 may store various items that can be applied to a game stage. The item may include a block-exchange-time increase item capable of increasing the allowable number of exchanging block position, and a special block creation item capable of generating a special block that may eliminate at least one puzzle block in the game stage. The item may be acquired through game performance in the game stage, mission completion, etc., or may be acquired by various payment methods and other methods.

Hereinafter, a process performed by the game system 300 and/or the user terminal 400 will be described in detail.

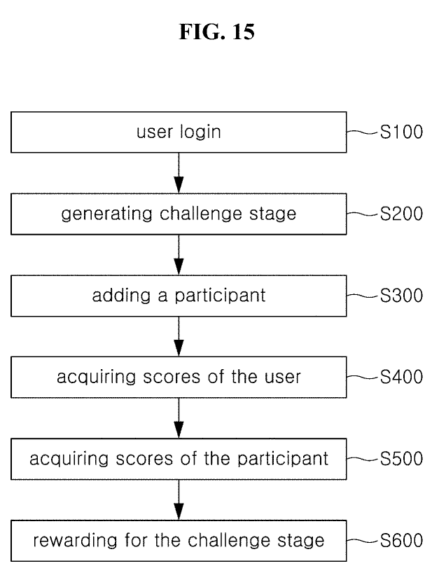

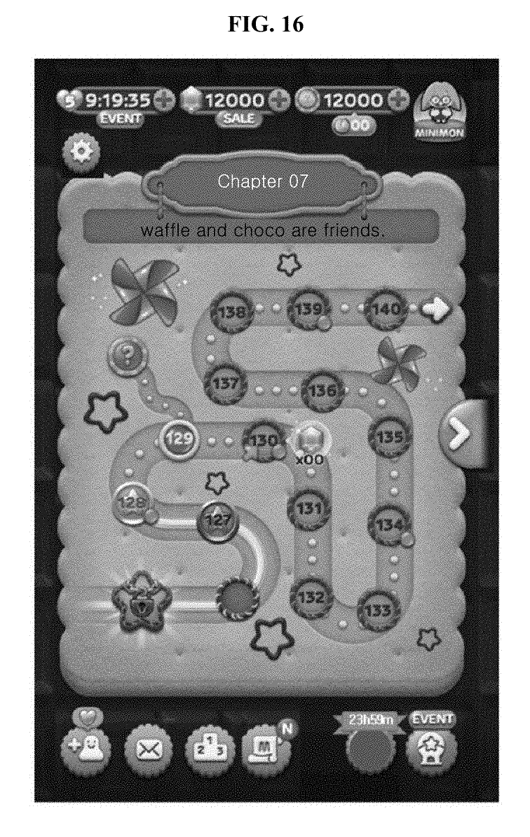

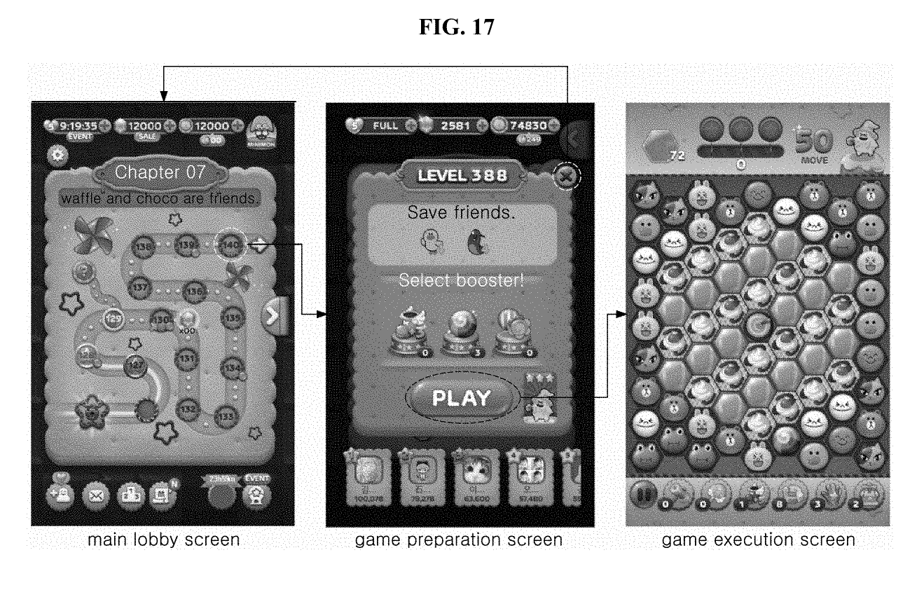

FIG. 15 is a flowchart illustrating a puzzle game process performed by the game system of FIG. 13, FIG. 16 is an example of a main lobby screen displayed on the user terminal, and FIG. 17 is a diagram for explaining the relationship among the main lobby screen, the game preparation screen and the game execution screen displayed on the user terminal.

Referring to FIGS. 13 to 17, when the terminal 400 of the user A executes an installed game program, for example, a game app, the user A's terminal 400 accesses the main control unit 310 of the game system 300 via the network 20. Then, upon receiving login information of the user A from the user A's terminal 400, the main control unit 310 performs user login process to execute the game (S100). At this time, if the main control unit 310 has stored the login information of the user A at a previous login process for the user A, the main control unit 310 may automatically perform the login process without requiring any input of user information. The user login may be performed in conjunction with an account currently used by the user A, for example, an account of Google®, Facebook®, Naver, or the like.

When the user login process is completed, the terminal 400 of the user A displays the main lobby screen as shown in FIG. 16 or the left screenshot of FIG. 17. For example, the main control unit 310 may control the main lobby screen to be displayed on the terminal 400 of the user A after completing the user login process. The main lobby screen may, for example, include one of a plurality of chapters, and each of the chapters may include a plurality of general game stages. The game stages provided in the game system 300 may have a plurality of levels.

Then, the main control unit 310 may determines a game stage to be played (hereinafter referred to as a ‘play game stage’) according to a user input of selecting one of the general game stages. For example, when the user A selects one of the plurality of general game stages displayed on the main lobby screen as a play game stage, the user terminal 400 may display a game preparation screen, as shown in middle screenshot of FIG. 17. Here, the game preparation screen may include at least one of a preview display area for displaying the play game stage in advance, a character display area for displaying a game character to be applied to the play game stage, an item application unit for selecting at least one of items possessed by the user to apply the selected items to the play game stage, a ranking display area for displaying rankings of users registered as friends, an execution icon for executing the play game stage, and the like. On the other hand, if the user clicks the cancel icon, the game preparation screen may be returned to the main lobby screen.

Then, the main control unit 310 may perform a puzzle game in the play game stage in response to user input on the user through the user terminal 400. For example, when the user A clicks the execution icon displayed on the game preparation screen, the terminal 400 of the user A displays a game execution screen, as shown in the left screenshot of FIG. 17, to perform a puzzle game.

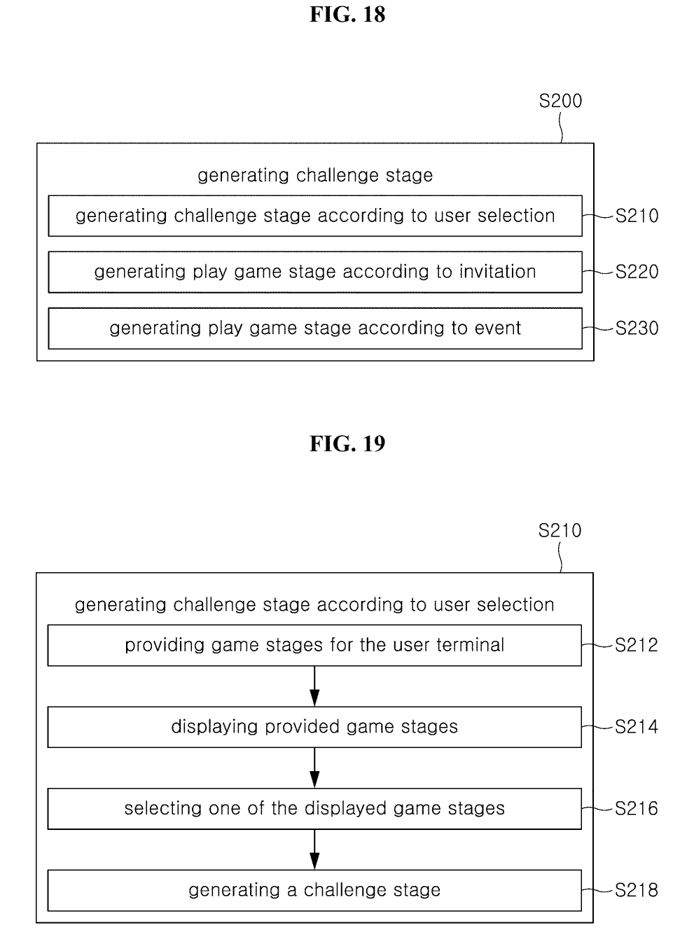

FIG. 18 is a diagram for explaining the challenge stage generating step of the puzzle game method of FIG. 15.

Referring to FIGS. 14, 15 and 18, after the user login step S100, the terminal 400 of the user A can participate in a game stage provided by the stage management unit 340. Hereinafter, the game stage in which the user A participates will be referred to as a ‘challenge stage’.

As described above, after the user login step S100, the stage management unit 340 receives a user input for participating in a game stage from the terminal 400 of the user A, the stage management unit 340 may generate a challenge stage (S200).

In the present exemplary embodiment, in step S200, the stage management unit 340 selects one of a method of generating the challenge stage by user selection from at least one game stage held by the user A (S210), a method of generating the play game stage by an external invitation message provided to the user A's terminal 400 (S220), and a method of selecting the play game stage by an event notification message provided to the user A's terminal 400 (S230).

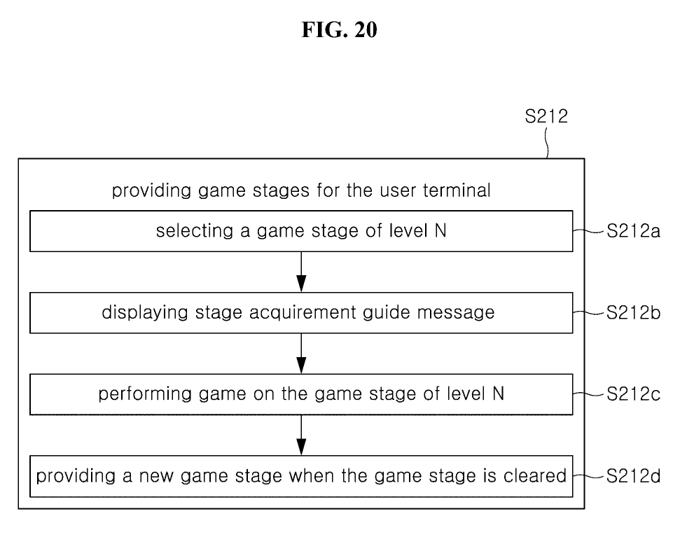

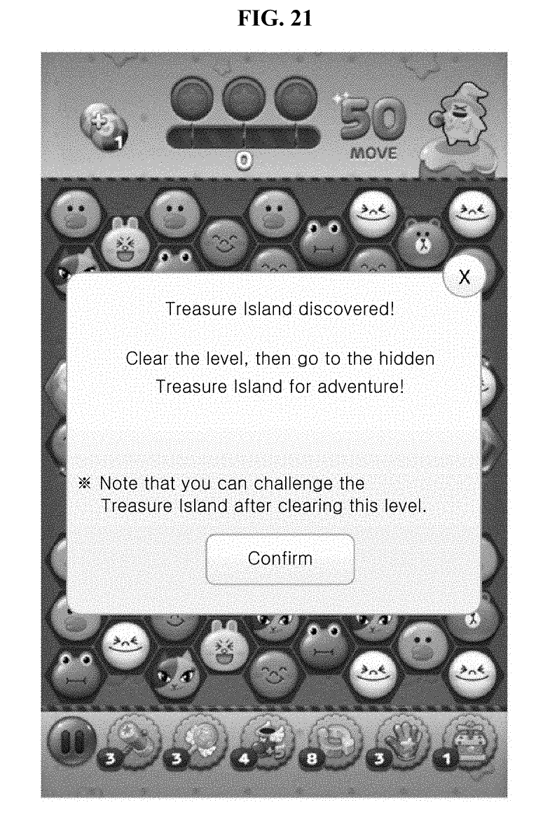

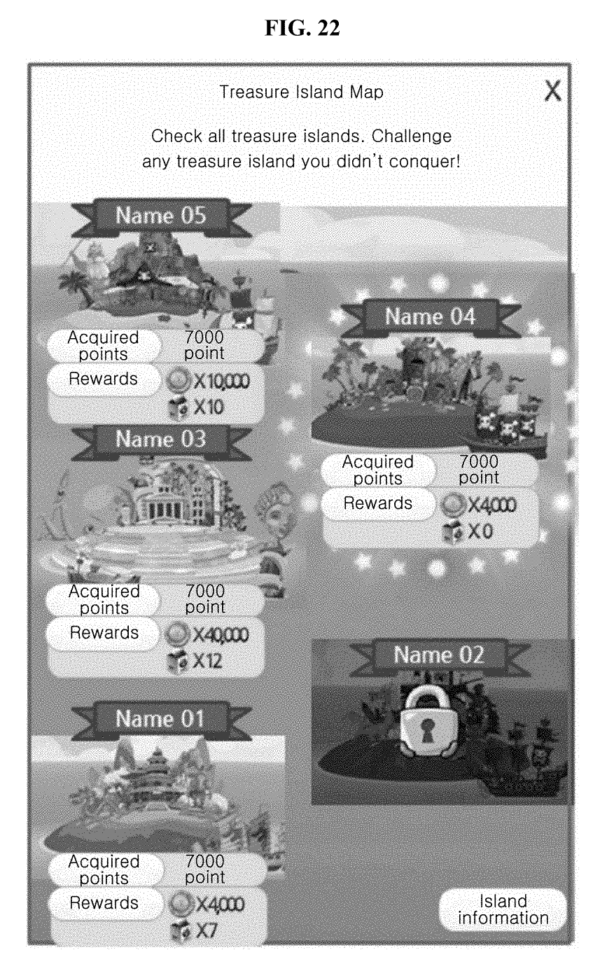

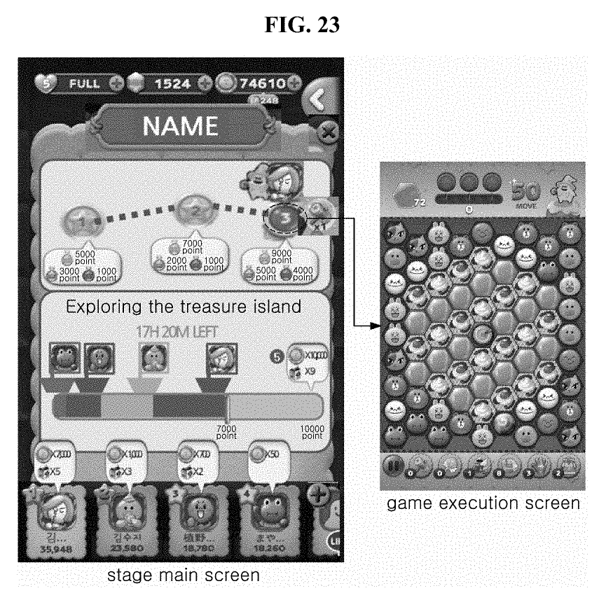

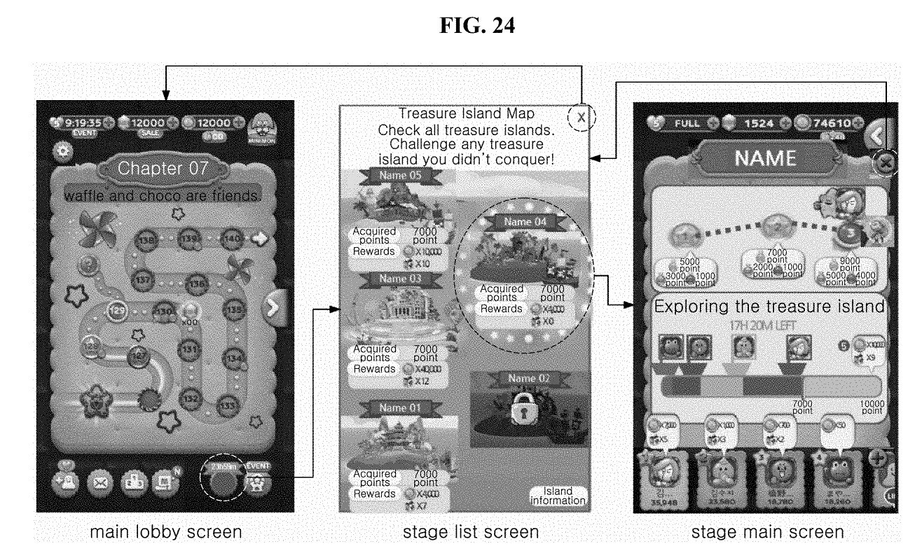

FIG. 19 is a flowchart for explaining a challenge stage generation method according to user selection, FIG. 20 is a flowchart for explaining the step of providing game stages of FIG. 19, FIG. 21 is an exemplary game stage discovery message displayed on the game execution screen, FIG. 22 is an exemplary stage list scree displayed on the user terminal, FIG. 23 is a diagram for explaining the relationship between the stage lobby screen and the game execution screen displayed on the user terminal, and FIG. 24 is a diagram for explaining the relationship among the main lobby screen, the stage list screen, and the stage lobby screen displayed on the user terminal.

Referring to FIGS. 13, 14 and 19 to 24, the stage management unit 340 may generate the challenge stage by selecting one of at least one game stage held by the user A (S210).

According to the result of performing the puzzle game in a game stage on the user A's terminal 400, the stage management unit 340 provides a game stage (S212). As a result, the terminal 400 of the user A may acquire and own the game stage provided by the stage management unit 340.

The step S212 will be described in more detail as below.

When the user A selects a level N game stage among the general game stages composed of a plurality of levels in the main lobby screen as shown in FIG. 16, the user terminal 400 may transmit information on user selecting the level N game stage to the stage management unit 340 (S212a). Here, N is an integer of 1 or more. As a result, the stage management unit 340 may display the level N game stage on the terminal 400 of the user A. That is, the user A's terminal 400 may display a game execution screen for the level N game stage.

Then, the stage manager 340 displays a message indicating that a game stage can be acquired when the level N game stage is cleared (S212b). For example, a stage discovery pop-up message may be displayed as shown in FIG. 21 on the terminal 400 of the user A. That is, the terminal 400 of the user A may display the stage discovery pop-up message as shown in FIG. 21 after or at the same time displaying the game execution screen. On the other hand, treasure islands are used as examples of game stages in the following drawings including FIG. 21.

Then, the stage management unit 340 may execute the puzzle game of the level N game stage on the terminal 400 of the user A (S212c). That is, the terminal 400 of the user A may perform the puzzle game of the level N game stage in response to user inputs.

If it is determined in step S212c that the game stage of level N has been cleared, the stage management unit 340 may provide a new game stage to the user A's terminal 400 (S212d). That is, when the user terminal 400 of the user A clears the game stage of the level N, the user terminal 400 may receive a new game stage from the stage manager 340 and retain it.

As described above, after the step S212 of providing a new game stage is performed, the stage management unit 340 may displays the game stages held by the user A on the terminal 400 of the user A, for example, in the stage list screen as shown in FIG. 22 (S214). At this time, a plurality of game stages held by the user A may be displayed on the stage list screen, i.e., the treasure island map.

The stage management unit 340 may display the game stages held by the user A only for a predetermined period. For example, when the predetermined time has passed for a stage, the stage manager 340 may delete the stage from stage list screen or may display the stage in a locked state where selection of the stage is impossible.

Then, the terminal 400 of the user A may provide the stage management unit 340 with the stage selection information in response to user selection of one of the game stages displayed on the stage list screen (S216). That is, the stage management unit 340 may receive the stage selection information from the terminal 400 of the user A.

Then, the stage management unit 340 may generate the challenge stage using the stage selection information (S218). At this time, the stage manager 340 may display the stage main screen for the challenge stage on the user terminal 400 of the user A. That is, the user terminal 400 of the user A may display the stage main screen for the challenge stage and generate the challenge stage in response to user selecting a game stage desired to participate in.

The stage main screen may include a game stage display area where a plurality of special game stages can be accessed, a contribution display area for displaying the contribution of users participating in the stage, and a participant display area for displaying a list of users participating in the stage. The users displayed in the participant display area may include at least one user (hereinafter referred to as ‘participant’) other than the user A, and each user may be displayed in the ranking order according to acquired game scores.

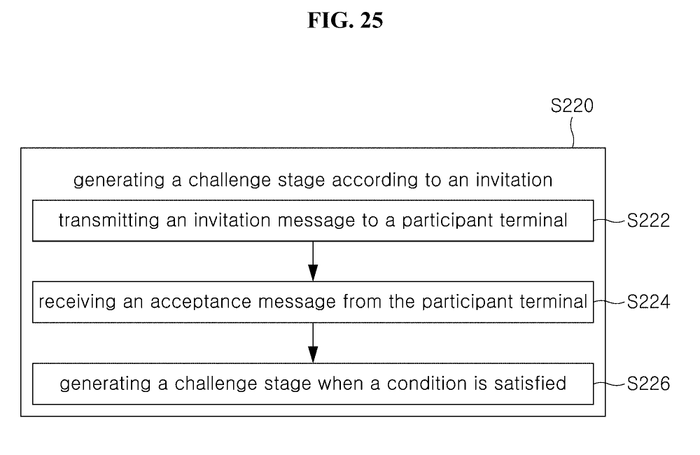

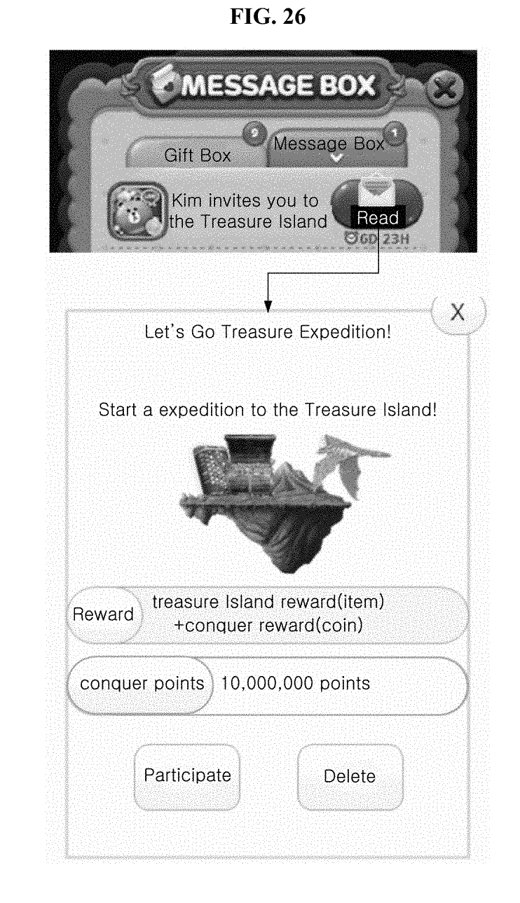

FIG. 25 is a flowchart for explaining a challenge stage generation method according to an invitation, and FIG. 26 is a diagram illustrating an example of a message box and an external invitation message displayed on the user terminal.

Referring to FIGS. 13, 14, 25, and 26, the stage manager 340 may generate the challenge stage in response to an external invitation message provided for the terminal 400 of the user A (S220).

In the step S220, the stage manager 340 may transmit the external invitation message generated by the user terminal of another user C to the terminal 400 of the user A (S222). That is, when the terminal 400 of the other user C transmits the external invitation message to the stage manager 340 to add the user A to the challenge stage in which the other user C participates, the stage manager 340 transmits the external invitation message to the user A's terminal 400. At this time, the external invitation message may be stored in the message box of the user A's terminal 400, and the user A's terminal 400 may display the external invitation message through the message box.

Then, the stage management unit 340 receives a participation acceptance message for the external invitation message from the terminal 400 of the user A (S224). That is, when the user A clicks the participation acceptance icon of the external invitation message, the terminal 400 of the user A can transmit a participation acceptance message to the stage management unit 340. On the other hand, if the user A clicks the delete icon of the external invitation message, the corresponding message may be deleted from the message box.

Then, the stage management unit 340 may generate the challenge stage in response to the participation acceptance message (S226). That is, the terminal 400 of the user A may perform the challenge stage by acquiring the game stage to which the user A is invited by the external invitation message.

The stage management unit 340 may generate the challenge stage only when a stage generation condition is satisfied even though the participation acceptance message is received.

For example, the stage management unit 340 may generate the challenge stage to provide the invited game stage to the terminal 400 of the user A only if, at the time of the participation acceptance message being received, there is no previously created challenge stage, the game stage of invitation is not cleared, and the number of users participating in the game stage of invitation is less than a maximum participation number. Here, the absence of the previously created challenge stage may mean that the user A does not have any game stage.

On the other hand, if the stage management unit 340 receives a participation acceptance message but the stage generation condition is not satisfied, stage management unit 340 may transmit a message indicating that the game stage of invitation cannot be acquired by the user A's terminal 400.

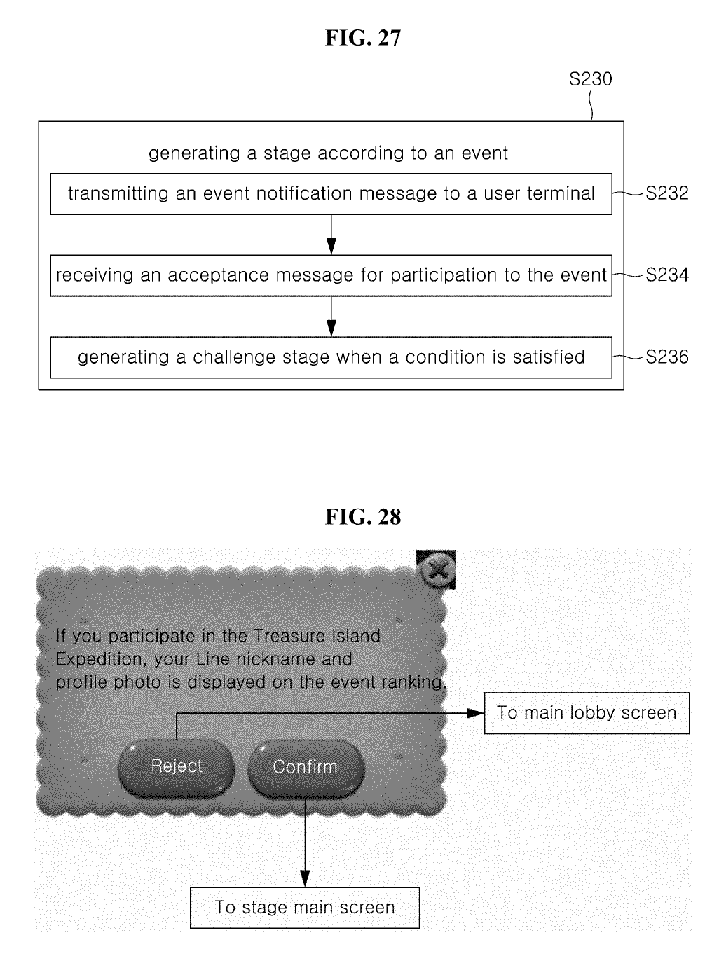

FIG. 27 is a flowchart for explaining a stage generation method according to an event, and FIG. 28 is an example of an event notification message displayed on the user terminal.

Referring to FIGS. 13, 14, 27 and 28, the stage manager 340 may generate the challenge stage in response to an event notification message provided to the terminal 400 of the user A (S230).

In the event generation step S230, the stage management unit 340 may generate an event notification message and then transmit the generated event notification message to the user A's terminal 400 (S232). In this case, the event notification message may be stored in the message box of the user A, and the terminal 400 of the user A may display the event notification is message. Alternatively, the event notification message may be displayed on the main lobby screen in a pop-up form as shown in FIG. 28 for a predetermined time.

Then, the stage management unit 340 may receive a participation acceptance message from the terminal 400 of the user A (S234). That is, when the user A clicks the participation acceptance icon of the event notification message, the terminal 400 of the user A may transmit a participation acceptance message to the stage management unit 340. On the other hand, if the user A clicks the participation rejection icon of the event notification message, the corresponding message can be deleted.

Then, the stage management unit 340 may generate the challenge stage in response to the participation acceptance message (S236). That is, the terminal 400 of the user A may generate the challenge stage by acquiring the game stage to which the user A's device 400 is invited by the event notification message.

The stage management unit 340 may generate the challenge stage only when a stage generation condition is satisfied even though the participation acceptance message for the event notification message is received.

For example, the stage management unit 340 may generate the challenge stage to provide the invited game stage to the terminal 400 of the user A only if, at the time of the participation acceptance message being received, there is no previously created challenge stage, the game stage of invitation is not cleared, and the number of users participating in the game stage of invitation is less than a maximum participation number. Here, the absence of the previously created challenge stage may mean that the user A does not have any game stage.

On the other hand, if the stage management unit 340 receives a participation acceptance message but the stage generation condition is not satisfied, stage management unit 340 may transmit a message indicating that the game stage of invitation cannot be acquired by the user A's terminal 400.

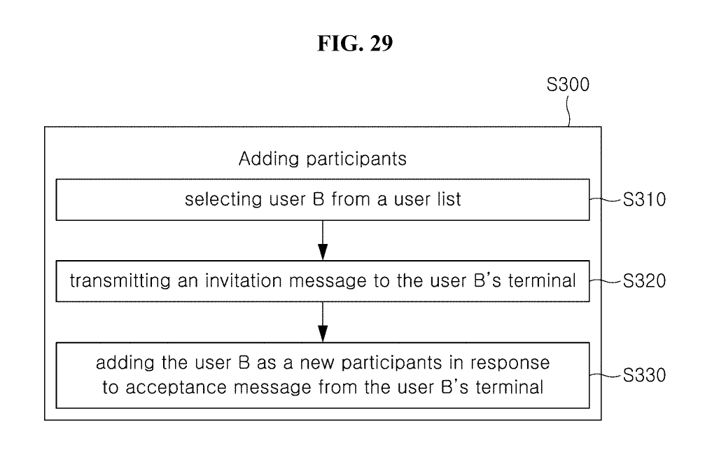

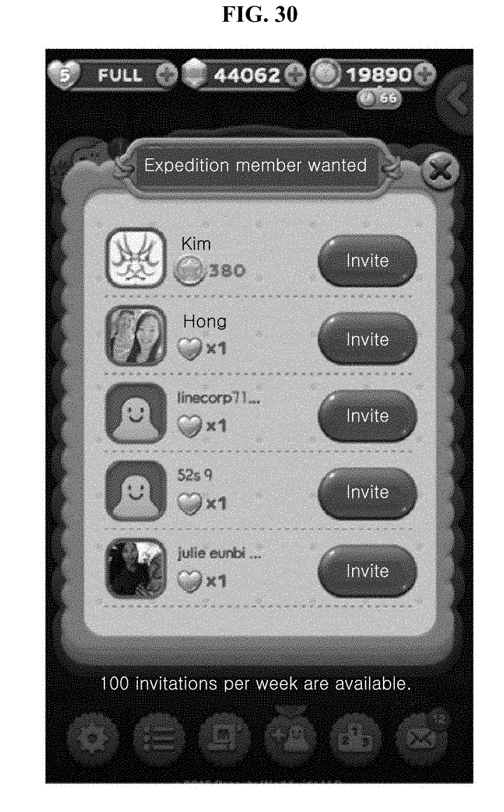

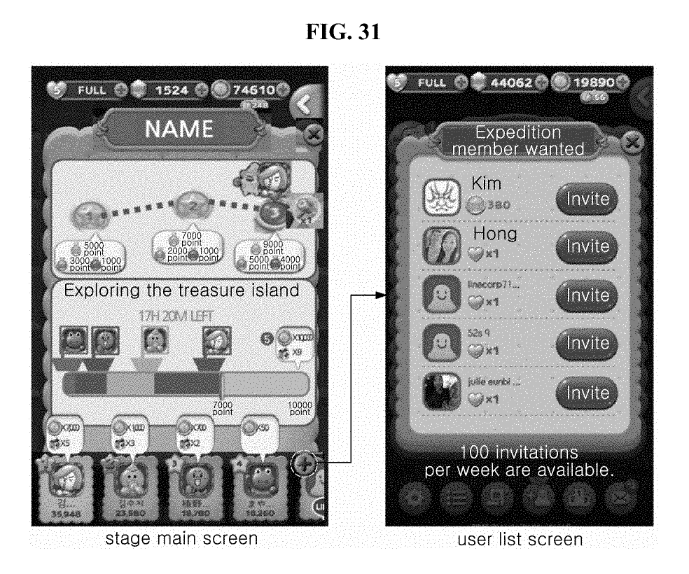

FIG. 29 is a flow chart for explaining a participant adding step of the puzzle game method of FIG. 15, FIG. 30 is an example of a user list screen displayed on the user terminal, and FIG. 31 is a diagram for explaining the relationship between the stage main screen and the user list screen.

Referring to FIGS. 14, 15, and 29 to 31, after the challenge stage is generated in step S200, the stage management unit 340 may add a new user who will participate in the challenge stage (hereinafter, ‘new participant’) (S300).

The step S300 will be described in more detail as below.

First, the stage management unit 340 receives, from the terminal 400 of the user A, information on a user A selecting a user B from the user list (S310).

For example, in the participant display area of the stage main screen displayed on the terminal 400 of the user A, as shown in the stage main screen of FIG. 31, when the number of users currently participating in the challenge stage is less than a maximum participation number, an invitation icon may be provided to add participants as many as the number of the rest. Accordingly, when the user A clicks the invitation icon, the terminal 400 of the user A displays the user list screen including the user list as shown in FIG. 30. When the user A clicks on the user B, who is one of the user lists, the terminal 400 of the user A can transmit the information on the user B to the stage manager 340.

Then, the stage manager 340 may transmit an invitation message to the user terminal 400 of the user B using the information of the user B (S320).

Then, when the terminal 400 of the user B generates a participation acceptance message in response to the invitation message and transmits the participation acceptance message to the stage management unit 340, the stage management unit 340 may determine and add the user B as a new participant in response to the participation acceptance message (S330). At this time, the new participant may be further displayed in the participant display area of the stage main screen.

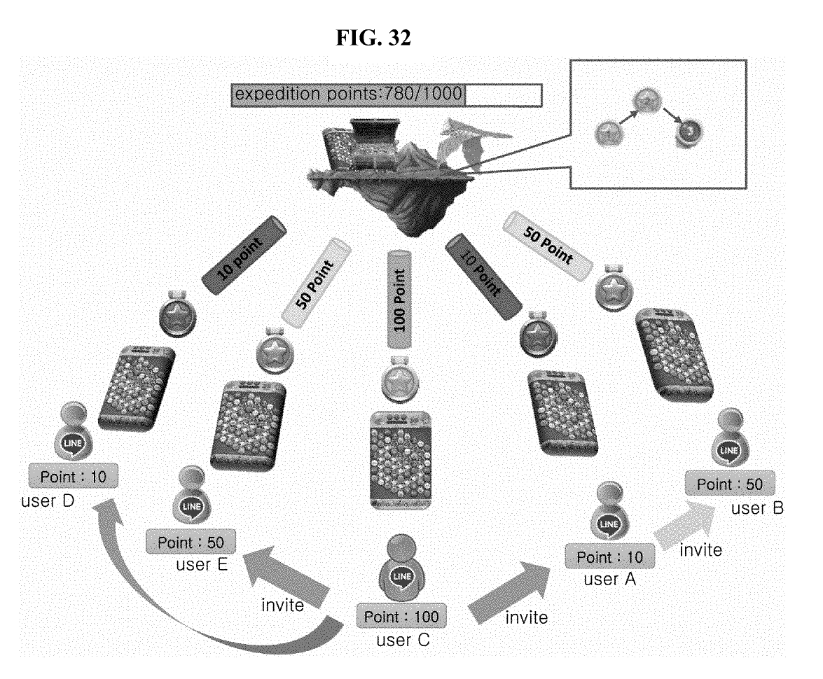

Referring to FIGS. 15 and 32, after the challenge stage is generated in step S200, the main control unit 310 may receive the game score of the user A obtained by performing the puzzle game in the challenge stage from the user A's terminal 400 (S400). That is, when the terminal 400 of the user A clears the challenge stage of the puzzle game, the user terminal 400 of the user A generates the game score of the user A and transmits the game score to the main control unit 310.

Subsequently, when the participant is participating in the challenge stage together, the main controller 310 receives the game score of the participant obtained by performing the s puzzle game in the challenge stage from the participant's terminal 400 (S500). That is, when the terminal 400 of the participant clears the challenge stage of the puzzle game, the terminal 400 of the participant generates the game score of the participant and transmits the game score to the main control unit 310.

Then, the game reward unit 330 receives the game score of the user A and the game score of the participant from the main control unit 310, calculates a total score by summing the scores of the user A and participant B, and provides the user terminals 400 of user A and participant, respectively, at least a part of the reward for clearing the challenge stage if the sum score reaches a reference score (i.e., conquer score) for the challenge stage (S600).

For example, the game reward unit 330 may provide the terminal of the user A is with a reward for a contribution of the user A to clearing the challenge stage, and provide the terminal of the participant with a reward for a contribution of the participant to clearing the challenge stage. Here, the contribution of the user A is a ratio of the game score of the user A to the sum score, and the contribution of the participant may be a ratio of the game score of the participant to the total score.

The contribution of the user A and the contribution of the participant may be displayed in the contribution display area of the stage main screen displayed on the user terminals 400 of the user A and the participant B. That is, the stage management unit 340 receives the game score of the user A and the game score of the participant from the main control unit 310, and displays the contribution of the user A and the contribution of the participant in the contribution display area of the user terminals 400. For example, the contribution of the user A and the contribution of the participant may be displayed in the form of a gauge bar, as shown in FIG. 23.

As described above, according to the present exemplary embodiment, when the user terminal 400 of the user A has the challenge stage where the user can perform the puzzle game together with a plurality of users, it is possible to transmit an invitation message to other users to add new participant for the challenge stage. Accordingly, a user can experience more pleasure because the user A can invite other users to perform a puzzle game together.

In addition, when the user A and the at least one participant participate in the challenge stage to perform the puzzle game, each of them can obtain its game score according to the game performance, respectively. At this time, when the game system 300 determines that the sum score of the acquired game scores reaches the reference score of the challenge stage, the game system 300 provides at least a part of the clear stage reward for each of the users. For example, the game system 300 may divide the reward for clearing the challenge stage according to the ratio of the game score of each user in the total score to provide the share for each of the users. Accordingly, the user A may be motivated to play the puzzle game harder in order to receive more reward than other participants.

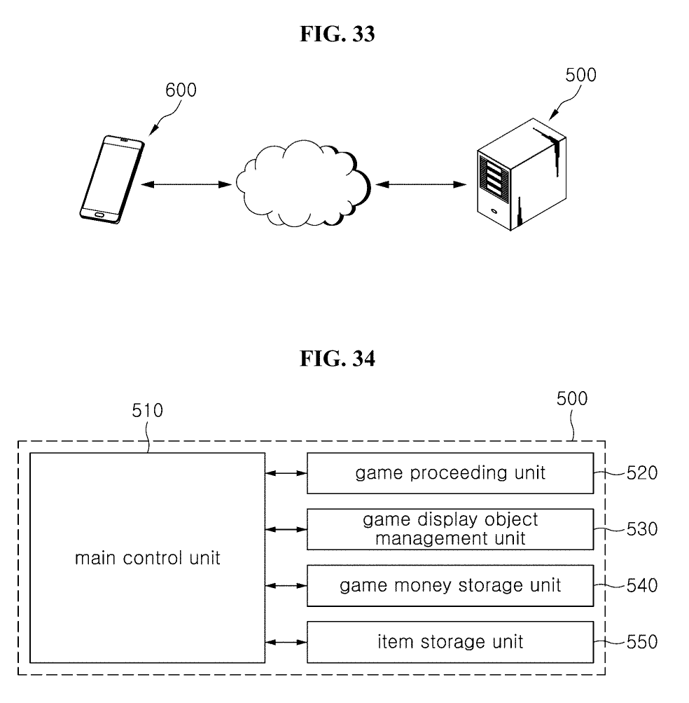

FIG. 33 is a conceptual diagram showing the connection relationship of the game system according to a third exemplary embodiment of the present invention, and FIG. 34 is a block diagram illustrating the game system of FIG. 33 in detail.

Referring to FIGS. 33 and 34, the game system 500 according to the present exemplary embodiment is a computer system connected to at least one user terminal 600 via a network 10 to provide a puzzle game. The game system 500 may include a main control unit 510, a game proceeding unit 520, a game display object management unit 530, a game money storage unit 540, and an item storage unit 550. The user terminal 400 may be a smart device including a smart phone, a tablet PC, and the like capable of running an application program and displaying various screens through a display unit.

In the present exemplary embodiment, the components of the game system 500 may be physically separate computer systems from each other, or functionally separate programs within one computer system. In addition, the components of the game system 500 may be physically or functionally separated programs within a plurality of computer systems.

The main control unit 510 may perform an interface function of connecting to the user terminal 600 through the network 30 to exchange signals with the user terminal 600 and may perform user login process in response to receiving login information of the user A from the user terminal 600. The user login may be performed in conjunction with an account currently used by the user A, for example, an account of Google®, Facebook®, Naver, and the like.

The main control unit 510 is connected to and controls the game proceeding unit 520, the game display object management unit 530, the game money storage unit 540 and the item storage unit 550, to perform a integrated management of the game.

After the user's login is completed by the main control unit 510, the game proceeding unit 320 executes the puzzle game on the user terminal 600 in response to receiving the game execution signal from the user terminal 600. Specifically, the game proceeding unit 520 displays puzzle blocks composed of a plurality of color types on the display unit of the user terminal 600, exchanges one of the puzzle blocks with one of neighboring puzzle blocks according to user manipulation input, and, when three or more puzzle blocks having the same color are arranged consecutively in at least one direction of the puzzle blocks, eliminates the three or more puzzle blocks.

In addition, the game proceeding unit 520 may provide various reward (e.g., game money, items, etc.) for the user terminal 600 according to the result of the puzzle game performed by the user terminal 600.

The game display object management unit 530 may provide a game display object for the user terminal 600 in exchange with the game money held by the user A. The game display object may include a landmark including a constructive architecture and a natural landscape. For example, the game display object may be a landmark such as Tokyo Tower, Mt. Fuji, Statue of Liberty, Golden Gate Bridge, Louvre Museum, Eiffel Tower, Tower Bridge, and the like. The game display object management unit 530 will be described later in detail with reference to the accompanying drawings.

The game money storage unit 540 stores game money of the user A. The game money may be acquired through game play on the game stage, mission completion, various is payment methods, and other methods.

The item storage unit 550 may store various items that can be applied to a game stage. The item may include a block-exchange-time increase item capable of increasing the allowable number of exchanging block position, and a special block creation item capable of generating a special block that may eliminate at least one puzzle block in the game stage. The item may be acquired through game execution of the game stage, mission completion, etc., or may be acquired by various payment methods and other methods.

Hereinafter, a process performed by the game system 500 or the user terminal 600 described above will be described in detail.

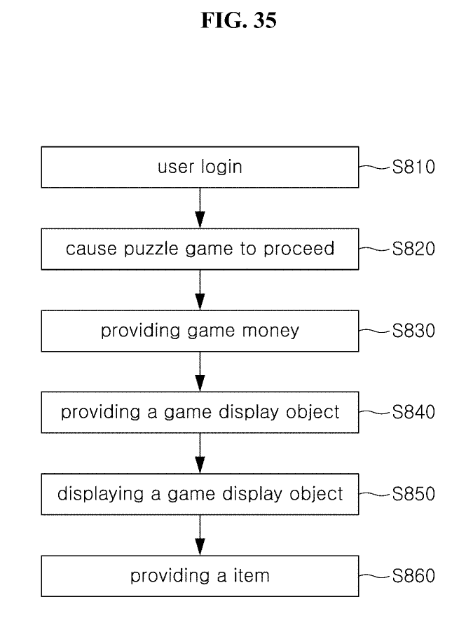

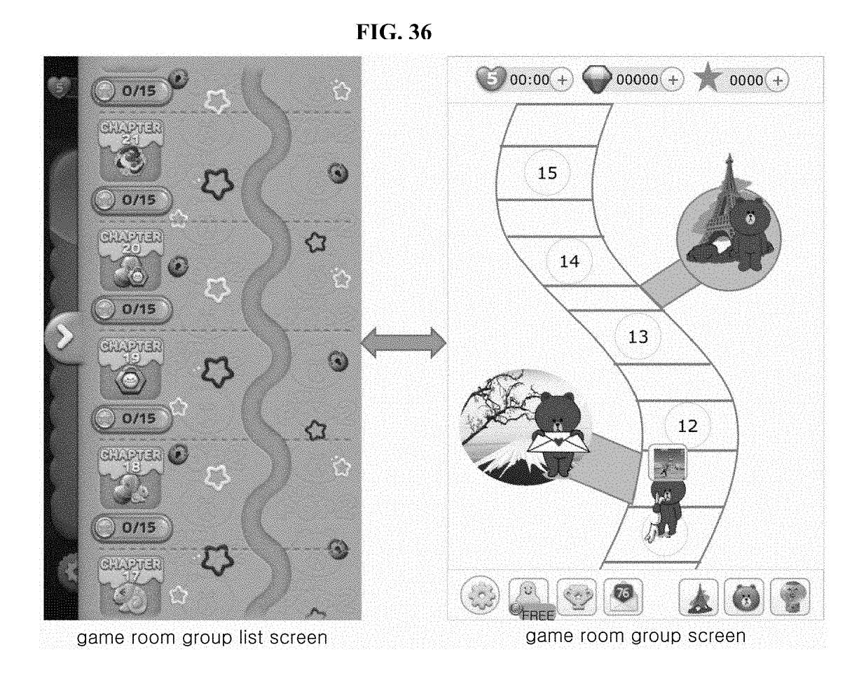

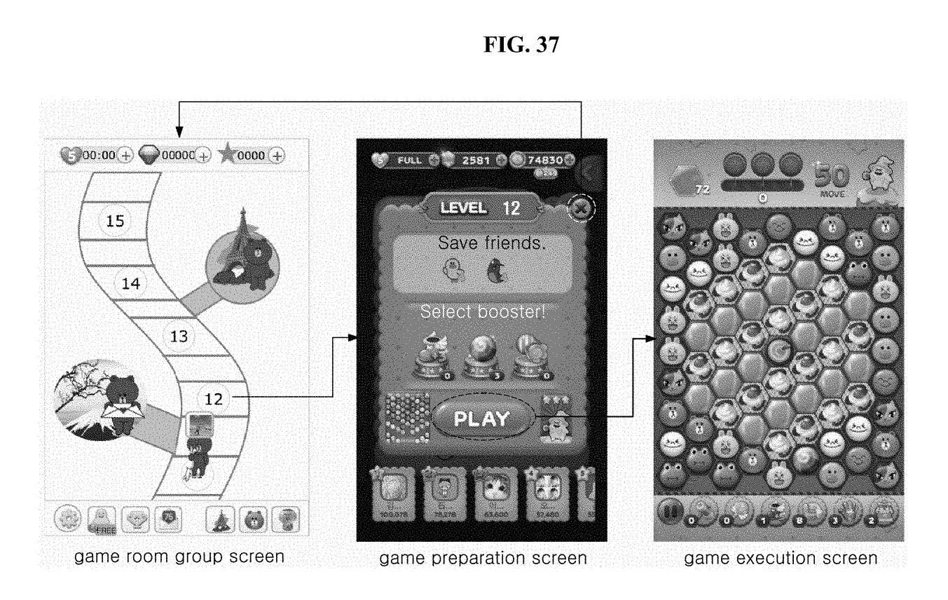

FIG. 35 is a flowchart illustrating a puzzle game method performed by the game system of FIG. 1, FIG. 36 is a diagram illustrating an example of a group room list screen and a game room group screen displayed on the user terminal, and FIG. 37 is a diagram for explaining the relationship among a game room group screen, a game preparation screen and a game s execution screen displayed on the user terminal.

Referring to FIGS. 33 to 37, in the puzzle game method according to the present exemplary embodiment, when the user terminal 600 executes a game program, for example, game application, the user terminal 600 accesses the main control unit 510 of the game system 500 through the network 10

When the user terminal 600 is connected to the main control unit 510, the main control unit 510 performs user log-in process in response to receiving login information of the user A from the user terminal 600 (S810). At this time, if the main control unit 510 stores the login information of the user A obtained in previous a login process of the user A, the main control unit 110 may automatically perform the login process without requiring any input information. The user login may be performed in association with an account currently used by the user A, for example, an account of Google®, Facebook®, Naver, or the like.

When the user login process is completed, the main control unit 510 may control the game proceeding unit 520 to cause the puzzle game to proceed on the user terminal 600 through. That is, the game proceeding unit 520 may cause the puzzle game to proceed on the user terminal 600 connected to the main control unit 510 (S820). Accordingly, the user terminal 600 may perform the puzzle game in response to user inputs.

The step S820 of the puzzle game will be described in detail as follows.

First, the game proceeding unit 520 may cause puzzle games to proceed in a plurality of game room groups. At this time, each of the game room groups may comprise game rooms of a plurality of levels.

For example, the game proceeding unit 520 may display a group room list screen for selecting one of the game room groups on the user terminal 600. Accordingly, the user terminal 600 may display the game room group list screen. The list of the game room groups is displayed on the group room list screen.

Then, the game proceeding unit 520 may to determine a play game room group where the puzzle game is performed in response to user selecting one of the game room groups. For example, when the user terminal 600 selects any one of the game room groups according to a user input, the information on the user selecting one of the game room groups may be transmitted to the game proceeding unit 520. Accordingly then, by using the information transmitted by the user terminal 600, the game proceeding unit 520 may determine a play game room group in which the puzzle game is to be performed. That is, the game proceeding unit 520 may determine the game room selected by the user terminal 600 as a play game room group.

Then, the game proceeding unit 520 may display a game room group screen for selecting one of the game rooms in the game room group on the user terminal 600. Accordingly, the user terminal 600 may switch the group room list screen to the game room group screen and display it. At this time, game rooms having a plurality of levels included in the game room group may be displayed on the game room group screen. For example, in the game room group screen, game rooms having a plurality of levels may be displayed in a form of a Monopoly^{TM} style board map.

In the present exemplary embodiment, when the user terminal 600 has information about a game room group previously selected, the game proceeding unit 520 may immediately display the game room group screen for the game room group previously selected without displaying the group room list screen. In addition, if the user terminal 600 performs a game for the first time, the game proceeding unit 520 does not display the group room list screen and immediately displays an arbitrary game room group screen, for example, a game room group s screen for the group room having the lowest level. On the other hand, when the user A wishes to play a puzzle game in a game room group other than the previously played game room group or the lowest game room group, the user terminal 600 may switch the game room group screen to the group room list screen to select a new game room group.

When the game room group screen showing the game room group is displayed, the game proceeding unit 520 may determine a game room where the puzzle game is played in response to user selecting one of the game rooms of a plurality of levels included in the game room group. For example, when the user terminal 600 selects any one of game rooms of a plurality of levels by a user input, information on the user selecting a game room may be transmitted to the game proceeding unit 520. Then, using the information provided from the user terminal 600, the game proceeding unit 520 may determine a game room where the puzzle game is played.

Then, the game proceeding unit 520 may display a game preparation screen to prepare the game for causing the puzzle game to proceed in the game room on the user terminal 600. Accordingly, the user terminal 600 may switch the game room group screen to the game preparation screen and display it. The game preparation screen may include at least one of a preview display area for displaying the play game stage in advance, a character display area for displaying a game character to be applied to the play game stage, an item application area for selecting one of at least one item to applying it to the play game stage, a ranking display area for displaying rankings of other users registered as friends, an execution icon for executing the play game stage, and the like. On the other hand, if the user clicks the cancel icon, the game preparation screen may be returned to the main screen. On the other hand, if the user clicks the cancel icon, the game preparation screen may be returned to the main lobby screen.

Subsequently, the game proceeding unit 520 may allow the user terminal 600 to enter a game stage to perform the puzzle game. For example, when the user clicks an execution icon displayed on the game preparation screen of the user terminal 600, the user terminal 600 may switch the game preparation screen to a game execution screen to perform the puzzle game.

As described above, when the puzzle game in the game stage is completed through the game proceeding step S820, the game proceeding unit 520 may derive game results performed by the user terminal 600 in the game stage A. That is, the game proceeding unit 520 may determine whether the user terminal 600 has succeeded in conquering the game stage A or not. In addition, the game proceeding unit 520 can determine game scores for the stage A even if the user terminal 600 succeeded in conquering the game stage A. For example, the game proceeding unit 520 may provide the user terminal 600 with any one of a gold medal, a silver medal, and a bronze medal according to the number of points obtained by performing the puzzle game.

Then, the game proceeding unit 520 may provide the game money for the user terminal 600 according to the game result preformed by the user terminal 600 in the game stage A (S830). More specifically, the game proceeding unit 520 may provide game money only when the user terminal 600 succeeds in conquering the game stage A. In this case, game money provided by the game proceeding unit 520 may depend on which one of the gold medal, the silver medal, and the bronze medal is won. The game money provided to the user terminal 600 may be accumulated and stored in a storage area for the user A of the game money storing unit 540.

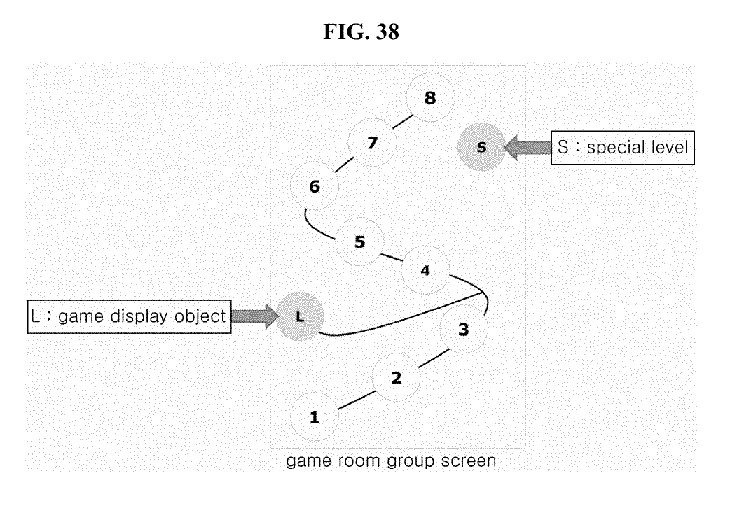

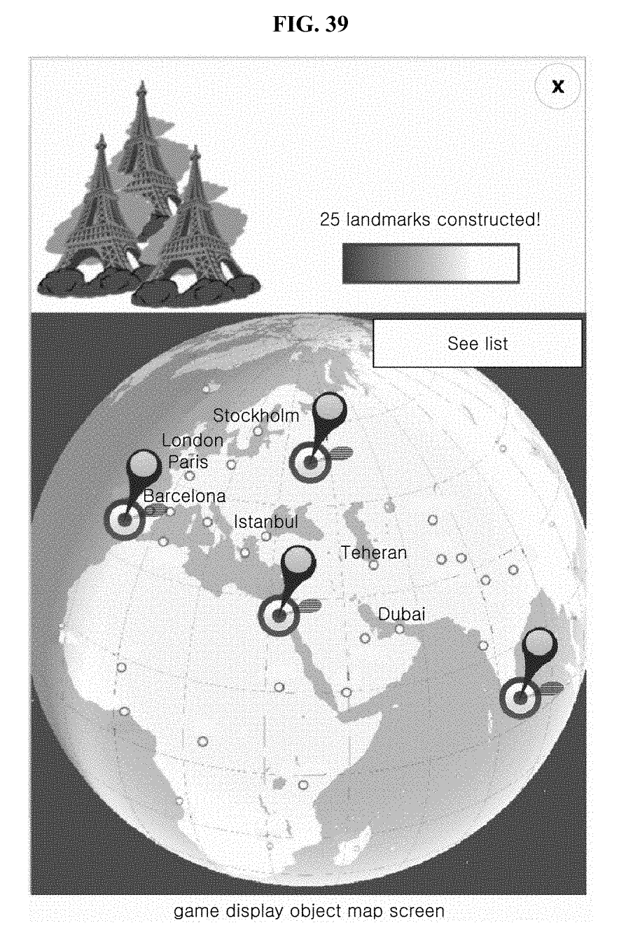

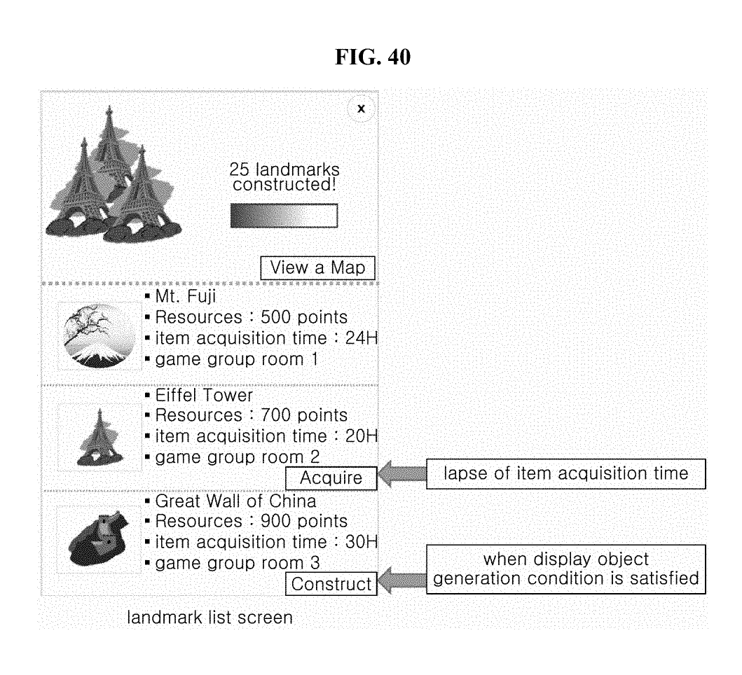

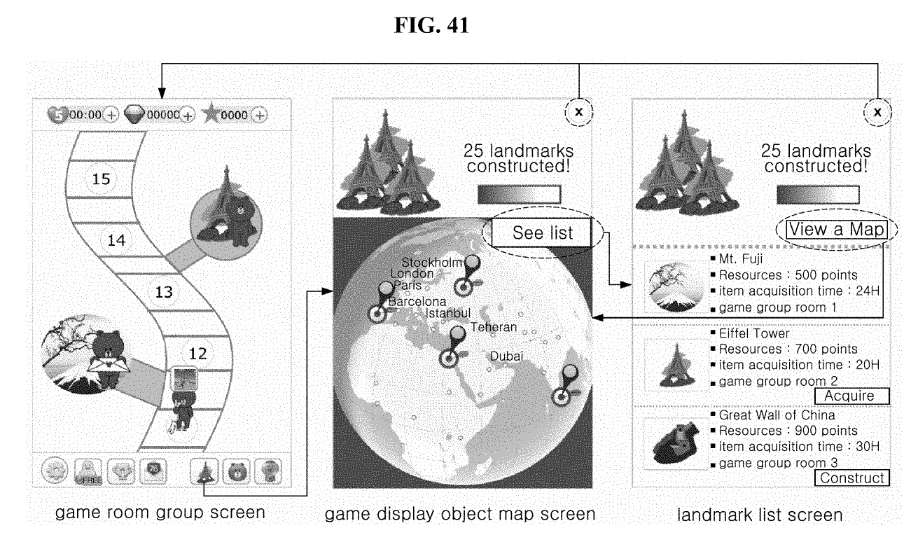

FIG. 38 is a simplified example of a game room group screen displayed on the user terminal, FIG. 39 is an exemplary game display object map screen displayed on the user terminal, FIG. 40 is an exemplary game display object list screen displayed on the user terminal, and FIG. 41 is a diagram for explaining the relationship between a game room group screen, a game display object map screen, and a game display object list screen displayed on the user terminal.

Referring to FIGS. 33, 34, and 38 to 41, the game display object management unit 530 may provide a game display object for the user terminal 600, using the game money stored in the game money storage unit 540 (S840). That is, the user terminal 600 can acquire the game display object using the game money stored in the game money storage unit 540.

The step of providing a game display object (S840) will be described in detail as follows.

First, the game display object management unit 530 can determine whether the game display object creation condition is satisfied. At this time, the game display object creation condition may be that the number of game rooms of a game room group having a score over a reference score is greater than a reference number. Specifically, supposing that the game room group is composed of 10 game rooms and eight or more game rooms of the game room group have a score equal to or greater than the reference score (e.g., a gold medal), the game display object management unit 530 may determine that the game display object generation condition is satisfied.

If the game management unit 530 determines that the game result performed by the user terminal 600 in a game room group satisfies the game display object generation condition, the game display object management unit 530 may provide the game display object for the user terminal 600 in exchange with game money stored in the storage unit 540. For example, if it is determined that the game progress result performed by the user terminal 600 in the game room group satisfies the game display object creation condition, and if the game money stored in the game money storage is more than the price of the game display object, the game display object management unit 530 may provide the game display object for the user terminal 600 in exchange with game moneys corresponding to the price. That is, if the game display creation condition is satisfied, the user terminal 600 may receive the game display object in exchange with paying the game money.

If the game display object is provided for the user terminal 600 in the step S840, the game display object management unit 530 may display the game display object on the user terminal 600 (S850). For example, the game display object management unit 530 may arrange the game display object in the game room group to display the game display object on the user terminal 600. Accordingly, the user terminal 600 may display a game room group screen in which the game display object is placed in the game room group.

In this exemplary embodiment, when the game proceeding unit 520 determines that the user terminal 600 has acquired a score equal to or greater than the reference score (for example, a gold medal) in all the game rooms of the game room group, the game proceeding unit 520 may add a special level game room to the game room group. For example, when it is determined that the user terminal 600 obtains a gold medal in all of the game rooms of the game room group, the game proceeding unit 520 may generate a special level game room and display the special level game room in the game room group screen including as shown in FIG. 38.

In this exemplary embodiment, at least one game display object may correspond to each of the game room groups. That is, since there is one or more game display object for each of the game room groups, the user terminal 600 may performs a game in one of the game room groups and acquire game display objects corresponding to the game room.

In the present exemplary embodiment, when the user terminal 600 acquires game display objects, the user terminal 600 may display the game display objects. For example, the user terminal 600 may display any one of a game display object map screen displaying the acquired game display objects in a map form and a display list screen displaying the acquired game display in list form. That is, the game display object management unit 530 may display the acquired game display objects on the user terminal 600 in a list form or in a map form.

Also, the user terminal 600 may switch the game room group screen to either the game display object map screen or the game display object list screen, or may switch the game display object map screen to the game display object list screen and vice versa. That is, the game display object management unit 530 may display either the game display object map screen or is the game display object list screen on the user terminal 600.

In the present exemplary embodiment, when a game display object creation condition for at least one of the acquired game display objects is satisfied, a game display object creation icon, for example, ‘construct’ icon as shown in FIG.40, may be generated and displayed in the game display object list. In this case, when the user clicks the display creation icon, the corresponding game display object can be obtained and displayed by the user terminal 600.

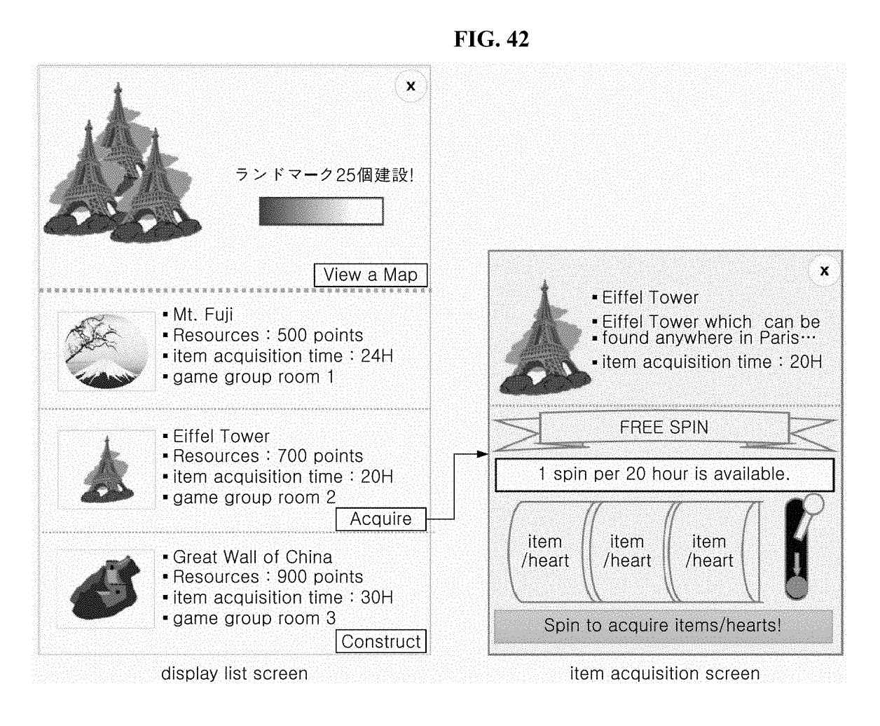

FIG. 42 is a diagram for explaining the relationship between the game display object list screen and the item acquisition screen displayed on the user terminal.

Referring to FIG. 42, if the user terminal 600 receives and holds the game display object, the game display object management unit 530 may provide an item for the user terminal 600 using the game display object (S860).

For example, the game display object may have an attribute to provide the item when an item acquisition time passes. Accordingly, the display management unit 530 may provide the item to the user terminal 600 when the item acquisition time has elapsed.

More specifically, the game display object management unit 530 determines whether the item acquisition time has passed or not based on when the user terminal 600 acquired the game display object for the first time or when the user terminal 600 previously acquired the item using the game display object. It is possible to determine whether. If it is determined that the item acquisition time has elapsed, the item may be provided to the user terminal 600. The provided item thus can be stored in a area for the user A of the item storage unit 550.

In the present exemplary embodiment, the game display object management unit 530 may provide the item for the user terminal 600 according to a result of an item acquisition is game even if the item acquisition time has passed.

More specifically, when it is determined that the item acquisition time has passed, the game display object management unit 530 provides an item acquisition game for the user terminal 600 and causes the item acquisition game to proceed.

Thereafter, when the user terminal 600 perform the item acquisition game in response to the user inputs, the game management unit 530 displays may determines whether to provide an item and/or what an item to be provided based on a result of performing the item acquisition game in the user terminal 600.

If it is determined that the item is to be provided, the game display object management unit 530 may provide the item for the user terminal 600.

In this exemplary embodiment, the item acquisition game may be a probability acquisition game in which one of a plurality of items is selected, for example, a spin acquisition game as shown in FIG. 41, and may be any of various other mini games.

As described above, according to the present exemplary embodiment, the user terminal 600 can acquire an arbitrary game display object using game money obtained by performing a puzzle game in a game room. Accordingly, the game system 500 may motivate a game user to continue playing the puzzle game to obtain game display objects, which may induce user interest and fun.

Also, even though the user has the game money more than price for acquiring the corresponding game display object, the corresponding game display can be obtained only when the number of game rooms of the game room group having a score over a reference score is higher than a reference number. Accordingly, the game system can induce a game user to enter not only the corresponding game room, but also other game rooms included in the game room group.

In addition, since various game display objects corresponds to each of a plurality of game room groups respectively, the game system may induce a game user to enter game room groups as many as possible.

The above-described method descriptions and the process flow diagrams are provided as illustrative examples and are not intended to require or ply that the steps of the various exemplary embodiments must be performed in the order presented. Instead, the order of steps in the foregoing exemplary embodiments may be performed in any order. Words such as “after” “the ext.” etc. are merely intended to aid the reader through description of the methods.

The various illustrative logical blocks, units, modules, circuits, and algorithm steps described in connection with the exemplary embodiments may be implemented as electronic hardware, computer software, or combinations of both. In order to describe the interchangeability of hardware and software, various illustrative features, blocks, units, modules, circuits, and steps have been described above in terms of their general functionality. Whether such functionality is implemented as hardware or software depends upon the particular application and design constraints for the overall system. A person of ordinary skill in the art may implement the functionality in various ways for each particular application without departing from the scope of the present invention.

The hardware used to implement the various illustrative logics, logical blocks, units, modules, and circuits described in connection with the exemplary embodiments disclosed herein may be implemented or performed with a general purpose processor, a digital signal processor (DSP) an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory processor-readable storage medium or a non-transitory computer-readable storage medium. Non-transitory computer-readable or processor-readable storage media may be any storage media that may be accessed by a computer or a processor. B_{y}, way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disc includes optically reproducible data such as a compact disc (CD), laser disc, optical disc, digital versatile disc (DVD), and blu-ray disc. Disk includes magnetically reproducible data such as a floppy disk. Combinations of the above are also is included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

Although certain exemplary embodiments and implementations have been described herein, other embodiments and modifications will be apparent from this description.

Accordingly, the inventive concept is not limited to such exemplary embodiments, but rather to the broader scope of the presented claims and various obvious modifications and equivalent arrangements.

What is claimed is:

1. A method for providing a puzzle game performed by a game server connected to a user terminal via s network comprising the steps of:
performing a user login process in response to receiving login information from the user terminal; and
executing the puzzle game on the user terminal in response to receiving a game execution signal from the user terminal,
wherein the step of executing the puzzle game comprises:
determining a game object having a game skill capable of performing a game action when a puzzle block elimination condition is satisfied;
displaying puzzle blocks, each of which has one of a plurality of colors, on a display unit of the user terminal;
exchanging one of the puzzle blocks with one of neighboring puzzle blocks according to a user input;
determining if a matching block group is generated as a result of exchanging puzzle blocks, the matching block group comprising at least three puzzle blocks having the same color that are arranged consecutively in a direction;
eliminating the matching block group; and
performing the game action if it is determined that the puzzle block elimination condition is satisfied according to a cumulative result of eliminating the puzzle blocks.

2. The method of claim 1,
wherein the puzzle block elimination condition is that X first type puzzle blocks are eliminated cumulatively (X is an integer equal to or greater than 1).

3. The method of claim 2, wherein the first type puzzle block comprises at least one of:
a general puzzle block that can be eliminated when the matching block group is formed; and
a special puzzle block capable of further eliminating at least one puzzle block when the special puzzle block forms a matching block group and the matching block group is eliminated

4. The method of claim 1, wherein the game action comprises at least on of:
a first action eliminating Z second type puzzle blocks when there is at least one second type puzzle block among the puzzle blocks displayed on the display unit(Z is an integer equal to or greater than 1);
a second action eliminating at least one puzzle block disposed in at least one specific area; and
a third action generating L special puzzle blocks (L is an integer equal to or greater than 1).

5. A puzzle game system comprising:
a main control unit configured to perform user login process in response to receiving login information from the user terminal;
a game execution unit configured to execute the puzzle game on the user terminal in response to receiving a game execution signal from the user terminal; and
an object management unit configured to determine a game object having a game skill capable of performing a game action when a puzzle block elimination condition is satisfied,
wherein the game execution unit is further configured to:
display puzzle blocks, each of which has one of a plurality of colors, on a display unit of the user terminal;
exchange one of the puzzle blocks with one of neighboring bocks according to a user input;
determine if a matching block group is generated as a result of exchanging puzzle blocks, the matching block group is composed of at least three puzzle blocks having the same color that is are arranged consecutively in a direction;
eliminate the matching block group; and
perform the game action if it is determined that the puzzle block elimination condition is satisfied according to a cumulative result of eliminating the puzzle blocks.

6. The game system of claim 5, wherein the puzzle block elimination condition is that X first type puzzle blocks are eliminated cumulatively (X is an integer equal to or greater than 1).

7. The method of claim 5, wherein the gam skill is capability of performing the game action Y times when the puzzle block elimination condition is satisfied(Y is an integer equal to or greater than 1).

8. A method for providing a puzzle game performed by a game server connected to a user terminal of a user via s network comprising steps of:
performing a user login process in response to receiving login information from the user terminal; and
receiving a game score of a first user obtained by performing the puzzle game in a game stage in which the first user participates from a first user terminal of the first user;
receiving a game score of a second user by performing the puzzle game in the game stage from a second user terminal of the second user, wherein the second user participate in the game stage to perform the puzzle game together with the first user; and
transmitting at least a part of a reward for clearing the stage to the first and second terminals, respectively, when a total score that is a sum of the score obtained by the first user and the second user reaches a reference score.

9. The method of claim 8, wherein the step of transmitting at least a part of reward comprises steps of:
providing a first share of the reward to the first terminal according to a contribution of the first user to clearing the stage; and
providing a second share of the reward to the second terminal according to a contribution of the second user to clearing the stage,
wherein the contribution of first user is a ratio of the game score of the first user to the total score, and the contribution of the second user is a ratio of the game score of the second user to the total score.

10. The method of claim 8, further comprising the step of adding a participant who is to participate in the game stage.

11. The method of claim 10, wherein the step of adding a participant comprises:
receiving information on user selecting a third user from a user list from the first user terminal;
generating an invitation message using the information;
transmitting the invitation message to a third user terminal of the third user; and
determining the third user as a participant in the stage in response to receiving a participation acceptance message from the third user terminal.

12. A puzzle game system comprising:
a main control unit configured to perform user login process in response to receiving login information from the user terminal, to receive a game score of a first user obtained by performing the puzzle game in a game stage in which the first user participates from a first user terminal of the first user, and to receive a game score of a second user by performing the puzzle game in the game stage from a second user terminal of the second user, wherein the second user participate in the game stage to perform the puzzle game together with the first user; and
a game reward unit configured to transmit at least a part of reward for clearing the stage to the first and second terminals, respectively, when a total score that is a sum of the score obtained by the first user and the second user reaches a reference score.

13. The puzzle game system of claim 12, further comprising a stage manager configured to add a participant who is to participate in the game stage.

14. A method for providing a puzzle game performed by a game server connected to a user terminal of a user via a network comprising the steps of:
performing a user login process in response to receiving login information from the user terminal;
allowing the user terminal access a game room to perform the puzzle game;
providing game money to the user terminal according to a game result performed by the user terminal in the game room; and
providing a game display object for the user terminal in exchange with the game money.

15. The method of claim 14, wherein the step of providing a game display object comprises the steps of:
determining whether a game display object creation condition is satisfied; and
providing the game display for the user terminal in exchange with the game money if the game display object creation condition is satisfied.

16. The method of claim 15, wherein the step of allowing the user terminal access a game room to perform the puzzle game comprises:
displaying a game room group comprising a plurality of game rooms on the user terminal, wherein the game rooms have a plurality of levels;
determining a play game room in response to the user selecting one of the plurality of game rooms of the game room group; and
allowing the user terminal to enter the game room to perform the puzzle game.

17. The method according to claim 16,
wherein the game display object creation condition is that a number of game rooms of the game room group having a score over a reference score is greater than a reference number.

18. A puzzle game system comprising:
a main control unit configured to perform user login process in response to receiving login information from the user terminal;
a game proceeding unit configured to allow the user terminal access a game room to perform the puzzle game, and to provide game money to the user terminal according to a game result performed by the user terminal in the game room; and
a game display object management unit configured to provide a game display object for the user terminal in exchange with the game money.

19. The apparatus according to claim 18, wherein the game display object management unit is further configured to:
determine whether a game display object creation condition is satisfied; and
provide the game display for the user terminal in exchange with the game money if the game display object creation condition is satisfied.

20. The game apparatus according to claim 19, wherein the game proceeding unit is further configured to:
display a game room group including a plurality of game rooms on the user terminal, wherein the game rooms have a plurality of levels;
determine a play game room in response to user selecting one of the plurality of game rooms of the game room group; and
allow the user terminal to enter the game room to perform the puzzle game.
